(19) United States
(12) Patent Application Publication
(10) Pub. No.: US 2026/0234511 A1
(43) Pub. Date: Aug. 13, 2026

(54) Enzymatic cleaner for an automated clinical analyzer and methods of use thereof

(71) Applicant: Siemens Healthcare Diagnostics Inc., Tarrytown, NY (US)

(72) Inventors: Jason Kellogg, Landenberg, PA (US); Si Yang, Garnet Valley, PA (US); Sandra A. Lewisch, Bear, DE (US); Izak Bahar, Hockessin, DE (US)

(73) Assignee: Siemens Healthcare Diagnostics Inc., Tarrytown, NY (US)

(21) Appl. No.: 19/153,418

(22) PCT Filed: Feb. 15, 2024
(86) PCT No.: PCT/US2024/015911

§ 371 Date: Aug. 4, 2025

Related U.S. Application Data
(60) Provisional application No. 63/486,727, filed on Feb. 24, 2023.

(51) Int. Cl. C11D 3/386; C11D 7/06; C11D 7/08; C11D 7/10; C11D 7/26; C11D 7/34

(52) U.S. Cl. CPC C11D 3/38618; C11D 3/38627; C11D 3/38636; C11D 7/06; C11D 7/08; C11D 7/10; C11D 7/267; C11D 7/34; C11D 2111/22; C11D 2111/44

(57) ABSTRACT

Provided are methods of cleaning an electrode sub-system. In some embodiments the method of cleaning an electrode sub-system involves providing a cleaning composition comprising: (i) one or more cleaning enzymes; (ii) one or more pH modulators; (iii) one or more matrix components; (iv) one or more buffer components; and (v) one or more preservatives, where the cleaning composition has a pH range of from about 7.2 to about 7.4. This method further involves flowing the cleaning composition through the electrode sub-system, wherein the electrode sub-system comprises an inlet port, one or more sensors, an outlet port, and a fluid flow channel connecting the inlet port, the one or more sensors, and the outlet port.

### CROSS REFERENCE TO RELATED APPLICATIONS

This application claims the benefit of priority of U.S. Provisional Patent Application Ser. No. 63/486,727, filed on Feb. 24, 2023, which is incorporated herein by reference in its entirety.

### FIELD

The present disclosure relates to an enzymatic cleaner for an automated clinical analyzer and methods for cleaning components of an automated clinical analyzer with an enzymatic cleaning solution.

### BACKGROUND

Immunoassay and chemistry analyzers are used to calculate the concentration of certain substances within samples of serum, plasma, urine, and/or other body fluids. Substances that can be analyzed through these instruments include certain metabolites, electrolytes, proteins, and/or drugs. Some immunoassay and chemistry analyzers can be used for in vitro diagnostic testing.

A primary goal of the chemical and bio sensors (such as ion selective electrode/sensors) within chemistry analyzers (also referred to herein as clinical or Atellica® analyzers) is to rapidly process high volumes of serum, plasma, and urine samples. As samples are processed over time, buildup (protein, lipids, etc) can be formed in the system, including the manifold, tubing, and the sub-assemblies (e.g., that includes an ion selective sensor system). Coatings of buildup change the interface of the sample and the system, impacting the capability of air/liquid detection. Excessive buildup also causes sample carryover, creating unstable signals, triggering detection errors, and deteriorating calibrations.

Some immunoassay and clinical chemistry analyzers currently clean the analyzer using a harsh cleaner, e.g., bleach. Some aspects of the analyzer may have their performance negatively impacted by the use of a harsh cleaner, e.g., Ion Selective Electrodes (ISE). The use of a cleaner that is not harmful to the performance and life of the electrodes is desirable.

The present disclosure is directed to overcoming these and other deficiencies in the art.

### SUMMARY

One aspect of the present disclosure is directed to a method of cleaning an electrode sub-system. This method involves providing a cleaning composition comprising: (i) one or more cleaning enzymes; (ii) one or more pH modulators; (iii) one or more matrix components; (iv) one or more buffer components; and (v) one or more preservatives, where the cleaning composition has a pH range of from about 7.2 to about 7.4. This method further involves flowing the cleaning composition through the electrode sub-system, wherein the electrode sub-system comprises an inlet port, one or more sensors, an outlet port, and a fluid flow channel connecting the inlet port, the one or more sensors, and the outlet port.

Another aspect of the present disclosure is directed to a method of cleaning an electrode sub-system. This method involves providing a cleaning composition comprising: (i) lipase; (ii) amylase; (iii) one or more pH modulators selected from hydrochloric acid and sodium hydroxide; (iv) one or more matrix components selected from the group consisting of bovine serum albumin, zinc chloride, and magnesium chloride hexahydrate; (v) HEPES buffer; and (vi) one or more preservatives selected from the group consisting of streptomycin sulfate, gentamicin sulfate, amphotericin B, and clotrimazole: where the cleaning composition has a pH range of from about 7.2 to about 7.4. This method further involves flowing the cleaning composition through the electrode sub-system, wherein the electrode sub-system comprises an inlet port, one or more sensors, an outlet port, and a fluid flow channel connecting the inlet port, the one or more sensors, and the outlet port.

### BRIEF DESCRIPTION OF THE DRAWINGS

FIGS. 1A-1D are graphs showing the calibration stability of K slopes and Standard A and B air readings on sensors treated with pancreatin from porcine pancreas (FIG. 1A), trypsin and lipase (FIG. 1B), lipase (FIG. 1C), and amylase (FIG. 1D).

FIGS. 2A-2D are graphs showing the calibration stability of K slopes and Standard A and B air readings on a sensor of mid volume testing treated with A-LYTE® IMT Cleaner every other week for a total of 4 treatments (FIG. 2A), a sensor of mid volume treated with A-LYTE® IMT Cleaner every other week starting day 28 for a total of 3 treatments (FIG. 2B), a sensor of high volume testing treated with A-LYTE® IMT Cleaner roughly every week for a total of 5 treatments (FIG. 2C), and a sensor of very high volume testing treated with A-LYTE® IMT Cleaner every 5000 samples (FIG. 2D).

FIG. 3 is a graph showing calibration stability of Na, K, and Cl sensors of one sensor cartridge before and after A-LYTE® IMT Cleaner treatment of 10 replicates and 50 replicates.

FIG. 4 is a graph showing calibration stability of Na, K, and Cl sensors of 3 sensor cartridges before and after A-LYTE® IMT Cleaner treatment of 50 replicates.

FIG. 5 is graph showing amylase stability in the A-LYTE® IMT Cleaner.

FIGS. 6A-6B are regression plots showing stability for lipase (FIG. 6A) and amylase (FIG. 6B).

FIG. 7 is a schematic showing the integrated multisensor technology (IMT) manifold assembly.

FIGS. 8A-8D are flow charts showing methods of cleaning a fluidic system according to the present disclosure. FIGS. 8A and 8C show methods of cleaning a fluidic system which involve combining a concentrated enzymatic cleaning composition with a diluent, flowing the diluted enzymatic cleaning composition through fluidic tubing, a cartridge comprising one or more ion selective sensors, and through an outlet port. FIGS. 8B and 8D show methods of cleaning a fluidic system which involve flowing an enzymatic cleaning composition through fluidic tubing, a cartridge comprising one or more ion selective sensors, and through an outlet port.

### DETAILED DESCRIPTION

### Definitions

Unless otherwise indicated, the definitions and embodiments described in this and other sections are intended to be applicable to all embodiments and aspects of the present disclosure herein described for which they are suitable as would be understood by a person skilled in the art.

Singular forms “a”, “an”, and “the” include plural references unless the context clearly dictates otherwise. Thus, for example, a reference to “a method” includes one or more methods and/or steps of the type described herein and/or which will become apparent to a person of ordinary skill in the art upon reading this disclosure. In another example, reference to “a compound” includes both a single compound and a plurality of different compounds.

The term “about” or “approximately” includes being within a statistically meaningful range of a value. Such a range can be within an order of magnitude, such as within 50%, or within 20%, or within 10%, or within 5% (or any amount or range within 5-50%) of a given value or range. The allowable variation encompassed by the term “about” or “approximately” may depend on the context.

The term “and/or” as used herein means that the listed features are present, or used, individually or in combination. In effect, this term means that “at least one of” or “one or more” of the listed features is used or present.

As will be understood by a person of ordinary skill in the art, for any and all purposes, such as in terms of providing a written description, all ranges disclosed herein also encompass any and all possible subranges and combinations of subranges thereof, as well as any value within a range. Any listed range can be easily recognized as sufficiently describing and enabling the same range being broken down into at least equal halves, thirds, quarters, fifths, tenths, and so on. As a non-limiting example, each range discussed herein can be readily broken down into a lower third, middle third and upper third, and so on. As will also be understood by a person of ordinary skill in the art all language such as “up to,” “at least,” and the like include the number recited and refer to ranges which can be subsequently broken down into subranges or specific values therein as discussed above. Finally, as will be understood by a person of ordinary skill in the art, and as discussed above, a range includes each individual value.

In understanding the scope of the present disclosure, the term “comprising” and its derivatives, as used herein, are intended to be open-ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “involving”, “having”, and their derivatives. The term “consisting” and its derivatives, as used herein, are intended to be closed terms that specify the presence of the stated features, elements, components, groups, integers, and/or steps, but exclude the presence of other unstated features, elements, components, groups, integers and/or steps. The term “consisting essentially of”, as used herein, is intended to specify the presence of the stated features, elements, components, groups, integers, and/or steps as well as those that do not materially affect the basic and novel characteristic(s) of features, elements, components, groups, integers, and/or steps. In embodiments or claims where the term comprising (or the like) is used as the transition phrase, such embodiments can also be envisioned with replacement of the term “comprising” with the terms “consisting of” or “consisting essentially of” The methods, kits, systems, and/or compositions of the present disclosure can comprise, consist essentially of, or consist of, the components disclosed.

In some embodiments comprising an “additional” or “second” component, the second component as used herein is different from the other components or first component. A “third” component is different from the other, first, and second components, and further enumerated or “additional” components are similarly different.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present disclosure, some embodiments of the methods and materials are now described. All publications mentioned herein are incorporated herein by reference to disclose and describe the methods and/or materials in connection with which the publications are cited.

Before the present disclosure is further described, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

### Methods of Cleaning an Electrode Subsystem

One aspect of the present disclosure is directed to a method of cleaning an electrode sub-system. This method involves (a) providing a cleaning composition comprising: (i) one or more cleaning enzymes; (ii) one or more pH modulators: (iii) one or more matrix components; (iv) one or more buffer components; and (v) one or more preservatives, wherein the cleaning composition has a pH range of from about 7.2 to about 7.4. This method further involves (b) flowing the cleaning composition through the electrode sub-system, where the electrode sub-system comprises an inlet port, one or more sensors, an outlet port, and a fluid flow channel connecting the inlet port, the one or more sensors, and the outlet port.

In some embodiments, the method further involves (c) flowing a rinsing solution through the electrode sub-system, wherein the flowing a rinsing solution is effective to remove any residual cleaning composition from the electrode sub-system.

Suitable rinsing solutions that can be used include water (such as dd water), buffer solutions (such as PBS (phosphate buffered saline), HEPES Free Acid (N-2-hydroxyethylpiperazine-N′-2-ethane sulfonic Acid), HEPES Na Salt (2-hydroxyethyl)piperazine-N′-(2-ethanesulfonic acid) sodium salt), phosphate, TRIS (2-amino-2-(hydroxymethyl)-1,3-propanediol), TES (2-[(2-hydroxy-1,1-bis(hydroxymethyl)ethyl)amino]ethane sulfonic acid), MOPS (3-(N-morpholino)propane sulfonic acid), PIPES (1,4-piperazinediethanesulfonic acid), TAPS ([tris(hydroxymethyl)methylamino]propanesulfonic acid), Bicine (N,N-Bis(2-hydroxyethyl)glycine). Tricine (N-[tris(hydroxymethyl)methyl]glycine), CAPSO (3-(cyclohexylamino)-2-hydroxy-1-propanesulfonic acid), Cacodylate (dimepreserthylarsenic acid), and MES (2-(N-morpholino)ethane sulfonic acid)), preservative solutions (such as antimicrobial or antifungal compositions), and combinations thereof.

In some embodiments, the cleaning composition is substantially free of sodium hypochlorite.

According to the present disclosure, the cleaning enzymes that can be used in the cleaning composition include, but are not limited to, an amylase, a lipase, a trypsin, a pepsin, and combinations thereof. In some embodiments, the cleaning enzymes that can be used in the cleaning composition include, but are not limited to, an amylase, a lipase, and combinations thereof.

The term “amylase” refers to an enzyme that catalyzes the hydrolysis of starch. Suitable exemplary amylases include, without limitation, alpha-amylase, beta-amylase, amyloglucosidase (glucoamylase), fungal amylase, and pullulanase.

The term “lipase” refers to an enzyme that catalyzes the hydrolysis of triglycerides. Suitable exemplary lipases include, without limitation, pancreatic lipases, microbial lipases, and plant lipases.

The terms “inlet port” and “entry port” are used interchangeably and refer to a point of entry into a system, such as a fluidic system.

According to the present disclosure, the one or more pH modulators that can be used in the cleaning composition include, but are not limited to, hydrochloric acid, sodium hydroxide, potassium hydroxide, calcium hydroxide, phosphoric acid, tetramethylammonium hydroxide. CAPSO free acid (3-(cyclohexylamino)-2-hydroxy-1-propanesulfonic acid), citric acid, acetic acid, CHES (2-(cyclohexylamino)ethanesulfonic acid), borate, and combinations thereof.

According to the present disclosure, the one or more matrix components that can be used in the cleaning composition include, but are not limited to, bovine serum albumin, human serum albumin, zinc chloride, and magnesium chloride hexahydrate.

According to the present disclosure, the one or more buffer components that can be used in the cleaning composition include, but are not limited to, HEPES Free Acid (N-2-hydroxyethylpiperazine-N′-2-ethane sulfonic Acid), HEPES Na Salt (2-hydroxyethyl)piperazine-N′-(2-ethanesulfonic acid) sodium salt), phosphate. TRIS (2-amino-2-(hydroxymethyl)-1,3-propanediol), TES (2-[(2-hydroxy-1,1-bis(hydroxymethyl)ethyl)amino]ethane sulfonic acid), MOPS (3-(N-morpholino)propane sulfonic acid), PIPES (1,4-piperazinediethanesulfonic acid), TAPS ([tris(hydroxymethyl)methylamino]propanesulfonic acid), Bicine (N,N-Bis(2-hydroxyethyl)glycine), Tricine (N-[tris(hydroxymethyl)methyl]glycine), CAPSO (3-(cyclohexylamino)-2-hydroxy-1-propanesulfonic acid), Cacodylate (dimethylarsenic acid), and MES (2-(N-morpholino)ethane sulfonic acid).

According to the present disclosure, the one or more preservatives that can be used in the cleaning composition include, but are not limited to, streptomycin sulfate, gentamycin sulfate, amphotericin B, clortrimazole, chloramphenicol, ampicillin, neomycin sulfate, isothiazolinones, and sodium gallate.

According to the present disclosure the cleaning composition has a pH range of from about 7.2 to about 7.4, from about 7.21 to about 7.39, from about 7.22 to about 7.38, from about 7.23 to about 7.37, from about 7.24 to about 7.36, from about 7.25 to about 7.35, from about 7.26 to about 7.34, from about 7.27 to about 7.33, from about 7.28 to about 7.32, from about 7.29 to about 7.4, from about 7.3 to about 7.4, from about 7.31 to about 7.39, from about 7.32 to about 7.39, from about 7.33 to about 7.39, from about 7.34 to about 7.39, or from about 7.35 to about 7.39.

In some embodiments, the cleaning composition further includes a diluent. Any suitable diluent can be used. For example, the diluent can be selected from the group consisting of water, a buffer, a saline-based solution, a preservative, a pH modulator, and albumin.

In some embodiments, the method further includes (d) calibrating the sensor.

Another aspect of the present disclosure is directed to a method of cleaning an electrode sub-system. This method involves (a) providing a cleaning composition comprising: (i) lipase; (ii) amylase; (iii) one or more pH modulators selected from hydrochloric acid and sodium hydroxide; (iv) one or more matrix components selected from the group consisting of bovine serum albumin, zinc chloride, and magnesium chloride hexahydrate; (v) HEPES buffer; and (vi) one or more preservatives selected from the group consisting of streptomycin sulfate, gentamicin sulfate, amphotericin B, and clotrimazole; where the cleaning composition has a pH range of from about 7.2 to about 7.4. This method further involves (b) flowing the cleaning composition through the electrode sub-system, wherein the electrode sub-system comprises an inlet port, one or more sensors, an outlet port, and a fluid flow channel connecting the inlet port, the one or more sensors, and the outlet port.

In some embodiments, the method further includes (c) flowing a rinsing solution through the electrode sub-system, wherein the flowing a rinsing solution is effective to remove any residual cleaning composition from the electrode sub-system. Any of the above-mentioned rinsing solutions can be used.

In some embodiments, the cleaning composition further comprises a diluent. Any suitable diluent can be used. For example, the diluent can be selected from the group consisting of water, buffer, saline-based solution, preservative, pH modulator, and albumin.

In some embodiments, the method further includes (d) calibrating the sensor.

In some embodiments, the lipase is present in the cleaning composition in an amount of at least about 100 U/L, at least about 200 U/L, at least about 300 U/L, at least about 400 U/L, at least about 500 U/L, at least about 600 U/L, at least about 700 U/L, at least about 800 U/L, at least about 900 U/L, at least about 1000 U/L, at least about 1100 U/L, at least about 1200 U/L, at least about 1300 U/L, at least about 1400 U/L, at least about 1500 U/L, at least about 1600 U/L, at least about 1700 U/L, at least about 1800 U/L, at least about 1900 U/L, at least about 2000 U/L, at least about 3000 U/L, at least about 4000 U/L, at least about 5000 U/L, at least about 6000 U/L, at least about 7000 U/L, at least about 8000 U/L, at least about 9000 U/L, at least about 10000 U/L, at least about 11000 U/L, at least about 12000 U/L, at least about 13000 U/L, at least about 14000 U/L, at least about 15000 U/L, or at least about 16000 U/L.

In some embodiments, the lipase is present in an amount within a range having a lower limit selected from 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, 7000 U/L, 8000 U/L, 9000 U/L, 10000 U/L, 11000 U/L, 12000 U/L, 13000 U/L, 14000 U/L, and 15000 U/L, and an upper limit selected from 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, 7000 U/L, 8000 U/L, 9000 U/L, 10000 U/L, 11000 U/L, 12000 U/L, 13000 U/L, 14000 U/L, 15000 U/L, and 16000 U/L.

In some embodiments, the lipase is present in the cleaning composition in an amount of about 100 U/L to about 16000 U/L; about 100 U/L to about 15000 U/L; about 100 U/L to about 14000 U/L; about 100 U/L to about 13000 U/L; about 100 U/L to about 12000 U/L; about 100 U/L to about 11000 U/L; about 100 U/L to about 10000 U/L; about 100 U/L to about 9000 U/L; about 100 U/L to about 8000 U/L; about 100 U/L to about 7000 U/L; about 100 U/L to about 6000 U/L; about 100 U/L to about 5000 U/L; about 100 U/L to about 4000 U/L; about 100 U/L to about 3000 U/L; about 100 U/L to about 2000 U/L; about 100 U/L to about 1900 U/L; about 100 U/L to about 1800 U/L; about 100 U/L to about 1700 U/L; about 100 U/L to about 1600 U/L; about 100 U/L to about 1500 U/L; about 100 U/L to about 1400 U/L; about 100 U/L to about 1300 U/L; about 100 U/L to about 1200 U/L; about 100 U/L to about 1100 U/L; about 100 U/L to about 1000 U/L; about 100 U/L to about 900 U/L; about 100 U/L to about 800 U/L; about 100 U/L to about 700 U/L; about 100 U/L to about 600 U/L; about 100 U/L to about 500 U/L; about 100 U/L to about 400 U/L; about 100 U/L to about 300 U/L; about 100 U/L to about 200 U/L; about 150 U/L to about 2000 U/L; about 150 U/L to about 1800 U/L; about 150 U/L to about 1600 U/L; about 150 U/L to about 1400 U/L; about 150 U/L to about 1200 U/L; about 150 U/L to about 1000 U/L; about 150 U/L to about 800 U/L; about 150 U/L to about 600 U/L; about 150 U/L to about 400 U/L; about 200 U/L to about 15000 U/L; about 300 U/L to about 14000 U/L; about 400 U/L to about 13000 U/L; about 500 U/L to about 12000 U/L; about 600 U/L to about 11000 U/L; about 700 U/L to about 10000 U/L; about 800 U/L to about 9000 U/L; about 900 U/L to about 8000 U/L; about 1000 U/L to about 7000 U/L; about 1000 U/L to about 6000 U/L; about 1000 U/L to about 5000 U/L; about 1000 U/L to about 4000 U/L; about 1000 U/L to about 3000 U/L; about 1000 U/L to about 2000 U/L; about 1000 U/L to about 1900 U/L; about 1000 U/L to about 1800 U/L; about 1000 U/L to about 1700 U/L; about 1000 U/L to about 1600 U/L; about 1000 U/L to about 1500 U/L; about 1000 U/L to about 1400 U/L; about 1000 U/L to about 1300 U/L; about 1000 U/L to about 1200 U/L; about 1000 U/L to about 1100 U/L; about 500 U/L to about 1900 U/L; about 600 U/L to about 1800 U/L; about 700 U/L to about 1700 U/L; about 800 U/L to about 1600 U/L; about 900 U/L to about 1600 U/L; about 1000 U/L to about 1600 U/L; about 1200 U/L to about 1600 U/L; about 1300 U/L to about 1600 U/L; or about 1400 U/L to about 1600 U/L.

In some embodiments, the amylase is present in the cleaning composition in an amount of at least about 50 U/L, at least about 60 U/L, at least about 70 U/L, at least about 80 U/L, at least about 90 U/L, at least about 100 U/L, at least about 200 U/L, at least about 300 U/L, at least about 400 U/L, at least about 500 U/L, at least about 600 U/L, at least about 700 U/L, at least about 800 U/L, at least about 900 U/L, at least about 1000 U/L, at least about 2000 U/L, at least about 3000 U/L, at least about 4000 U/L, at least about 5000 U/L, at least about 6000 U/L, at least about 7000 U/L, or at least about 8000 U/L.

In some embodiments, the amylase is present in an amount within a range having a lower limit selected from 50 U/L, 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, and 7000 U/L, and an upper limit selected from 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, 7000 U/L, and 8000 U/L.

In some embodiments, the amylase is present in the cleaning composition in an amount of about 50 U/L to about 8000 U/L; about 50 U/L to about 7000 U/L; about 50 U/L to about 6000 U/L; about 50 U/L to about 5000 U/L; about 50 U/L to about 4000 U/L; about 50 U/L to about 3000 U/L; about 50 U/L to about 2000 U/L; about 50 U/L to about 1000 U/L; about 50 U/L to about 900 U/L; about 50 U/L to about 800 U/L; about 50 U/L to about 700 U/L; about 50 U/L to about 600 U/L; about 50 U/L to about 500 U/L; about 50 U/L to about 400 U/L; about 50 U/L to about 300 U/L; about 50 U/L to about 200 U/L; about 50 U/L to about 100 U/L; about 70 U/L to about 800 U/L; about 100 U/L to about 8000 U/L; about 200 U/L to about 7000 U/L; about 300 U/L to about 6000 U/L; about 400 U/L to about 5000 U/L; about 500 U/L to about 4000 U/L; about 600 U/L to about 3000 U/L; about 700 U/L to about 2000 U/L; about 800 U/L to about 1000 U/L; about 500 U/L to about 2000 U/L; about 500 U/L to about 1500 U/L; about 500 U/L to about 1000 U/L; about 600 U/L to about 1000 U/L; about 600 U/L to about 900 U/L; or about 600 U/L to about 800 U/L.

In some embodiments, the cleaning composition includes trypsin. The trypsin may be present in the cleaning composition in an amount of at least about 50 U/L, at least about 60 U/L, at least about 70 U/L, at least about 80 U/L, at least about 90 U/L, at least about 100 U/L, at least about 200 U/L, at least about 300 U/L, at least about 400 U/L, at least about 500 U/L, at least about 600 U/L, at least about 700 U/L, at least about 800 U/L, at least about 900 U/L, at least about 1000 U/L, at least about 2000 U/L, at least about 3000 U/L, at least about 4000 U/L, at least about 5000 U/L, at least about 6000 U/L, at least about 7000 U/L, or at least about 8000 U/L.

In some embodiments, the trypsin is present in an amount within a range having a lower limit selected from 50 U/L, 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, and 7000 U/L, and an upper limit selected from 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, 7000 U/L, and 8000 U/L.

In some embodiments, the trypsin is present in the cleaning composition in an amount of about 50 U/L to about 8000 U/L; about 50 U/L to about 7000 U/L; about 50 U/L to about 6000 U/L; about 50 U/L to about 5000 U/L; about 50 U/L to about 4000 U/L; about 50 U/L to about 3000 U/L; about 50 U/L to about 2000 U/L; about 50 U/L to about 1000 U/L; about 50 U/L to about 900 U/L; about 50 U/L to about 800 U/L; about 50 U/L to about 700 U/L; about 50 U/L to about 600 U/L; about 50 U/L to about 500 U/L; about 50 U/L to about 400 U/L; about 50 U/L to about 300 U/L; about 50 U/L to about 200 U/L; about 50 U/L to about 100 U/L; about 70 U/L to about 800 U/L; about 100 U/L to about 8000 U/L; about 200 U/L to about 7000 U/L; about 300 U/L to about 6000 U/L; about 400 U/L to about 5000 U/L; about 500 U/L to about 4000 U/L; about 600 U/L to about 3000 U/L; about 700 U/L to about 2000 U/L; about 800 U/L to about 1000 U/L; about 500 U/L to about 2000 U/L; about 500 U/L to about 1500 U/L; about 500 U/L to about 1000 U/L; about 600 U/L to about 1000 U/L; about 600 U/L to about 900 U/L; or about 600 U/L to about 800 U/L.

In some embodiments, the cleaning composition includes pepsin. The pepsin may be present in the cleaning composition in an amount of at least about 50 U/L, at least about 60 U/L, at least about 70 U/L, at least about 80 U/L, at least about 90 U/L, at least about 100 U/L, at least about 200 U/L, at least about 300 U/L, at least about 400 U/L, at least about 500 U/L, at least about 600 U/L, at least about 700 U/L, at least about 800 U/L, at least about 900 U/L, at least about 1000 U/L, at least about 2000 U/L, at least about 3000 U/L, at least about 4000 U/L, at least about 5000 U/L, at least about 6000 U/L, at least about 7000 U/L, or at least about 8000 U/L.

In some embodiments, the pepsin is present in an amount within a range having a lower limit selected from 50 U/L, 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L. 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, and 7000 U/L, and an upper limit selected from 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, 7000 U/L, and 8000 U/L.

In some embodiments, the pepsin is present in the cleaning composition in an amount of about 50 U/L to about 8000 U/L; about 50 U/L to about 7000 U/L; about 50 U/L to about 6000 U/L; about 50 U/L to about 5000 U/L; about 50 U/L to about 4000 U/L; about 50 U/L to about 3000 U/L; about 50 U/L to about 2000 U/L; about 50 U/L to about 1000 U/L; about 50 U/L to about 900 U/L; about 50 U/L to about 800 U/L; about 50 U/L to about 700 U/L; about 50 U/L to about 600 U/L; about 50 U/L to about 500 U/L; about 50 U/L to about 400 U/L; about 50 U/L to about 300 U/L; about 50 U/L to about 200 U/L; about 50 U/L to about 100 U/L; about 70 U/L to about 800 U/L; about 100 U/L to about 8000 U/L; about 200 U/L to about 7000 U/L; about 300 U/L to about 6000 U/L; about 400 U/L to about 5000 U/L; about 500 U/L to about 4000 U/L; about 600 U/L to about 3000 U/L; about 700 U/L to about 2000 U/L; about 800 U/L to about 1000 U/L; about 500 U/L to about 2000 U/L; about 500 U/L to about 1500 U/L; about 500 U/L to about 1000 U/L; about 600 U/L to about 1000 U/L; about 600 U/L to about 900 U/L; or about 600 U/L to about 800 U/L.

In some embodiments, the cleaning composition includes pseudocholinesterase (PCHE). The PCHE may be present in the cleaning composition in an amount of at least about 1 U/mL, at least about 10 U/mL, at least about 20 U/mL, at least about 30 U/mL, at least about 40 U/mL, at least about 50 U/mL, at least about 60 U/mL, at least about 70 U/mL, at least about 80 U/mL, at least about 90 U/mL, at least about 100 U/mL, at least about 110 U/mL, at least about 120 U/mL, at least about 130 U/mL, at least about 140 U/mL, at least about 150 U/mL, at least about 160 U/mL, at least about 170 U/mL, at least about 180 U/mL, at least about 190 U/mL, or at least about 200 U/mL.

In some embodiments, the PCHE is present in an amount within a range having a lower limit selected from 1 U/mL, 10 U/mL, 20 U/mL, 30 U/mL, 40 U/mL, 50 U/mL, 60 U/mL, 70 U/mL, 80 U/mL, 90 U/mL, 100 U/mL, 110 U/mL, 120 U/mL, 130 U/mL, 140 U/mL, 150 U/mL, 160 U/mL, 170 U/mL, 180 U/mL, or 190 U/mL, and an upper limit selected from 5 U/mL, 10 U/mL. 20 U/mL, 30 U/mL, 40 U/mL. 50 U/mL, 60 U/mL, 70 U/mL, 80 U/mL, 90 U/mL, 100 U/mL, 110 U/mL, 120 U/mL, 130 U/mL, 140 U/mL, 150 U/mL, 160 U/mL, 170 U/mL, 180 U/mL, 190 U/mL, or 200 U/mL.

In some embodiments, the PCHE is present in the cleaning composition in an amount of about 1 U/mL to about 200 U/mL; about 1 U/mL to about 190 U/mL; about 1 U/mL to about 180 U/mL; about 1 U/mL to about 170 U/mL; about 1 U/mL to about 160 U/mL; about 1 U/mL to about 150 U/mL; about 1 U/mL to about 140 U/mL; about 1 U/mL to about 130 U/mL; about 1 U/mL to about 120 U/mL; about 1 U/mL to about 110 U/mL; about 1 U/mL to about 100 U/mL; about 1 U/mL to about 90 U/mL: about 1 U/mL to about 80 U/mL; about 1 U/mL to about 70 U/mL; about 1 U/mL to about 60 U/mL; about 1 U/mL to about 50 U/mL; about 1 U/mL to about 40 U/mL; about 1 U/mL to about 30 U/mL; about 1 U/mL to about 20 U/mL; about 1 U/mL to about 10 U/mL; about 5 U/mL to about 170 U/mL: about 10 U/mL to about 160 U/mL; about 20 U/mL to about 150 U/mL: about 30 U/mL to about 140 U/mL; about 40 U/mL to about 130 U/mL; about 50 U/mL to about 120 U/mL; about 60 U/mL to about 110 U/mL; about 70 U/mL to about 100 U/mL; about 10 U/mL to about 90 U/mL; about 10 U/mL to about 80 U/mL; about 10 U/mL to about 70 U/mL; about 10 U/mL to about 60 U/mL; about 10 U/mL to about 50 U/mL; about 10 U/mL to about 40 U/mL; about 10 U/mL to about 30 U/mL; or about 10 U/mL to about 20 U/mL.

In some embodiments, the cleaning composition includes gamma-glutamyl transpeptidase (GGT). The GGT may be present in the cleaning composition in an amount of at least about 50 U/L, at least about 60 U/L, at least about 70 U/L, at least about 80 U/L, at least about 90 U/L, at least about 100 U/L, at least about 200 U/L, at least about 300 U/L, at least about 400 U/L, at least about 500 U/L, at least about 600 U/L, at least about 700 U/L, at least about 800 U/L, at least about 900 U/L, at least about 1000 U/L, at least about 2000 U/L, at least about 3000 U/L, at least about 4000 U/L, at least about 5000 U/L, at least about 6000 U/L, at least about 7000 U/L, at least about 8000 U/L, or at least about 9000 U/L.

In some embodiments, the GGT is present in an amount within a range having a lower limit selected from 50 U/L, 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, 7000 U/L, and 8000 U/L, and an upper limit selected from 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, 7000 U/L, 8000 U/L, and 9000 U/L.

In some embodiments, the GGT is present in the cleaning composition in an amount of about 50 U/L to about 9000 U/L; 50 U/L to about 8000 U/L; about 50 U/L to about 7000 U/L; about 50 U/L to about 6000 U/L; about 50 U/L to about 5000 U/L; about 50 U/L to about 4000 U/L; about 50 U/L to about 3000 U/L; about 50 U/L to about 2000 U/L; about 50 U/L to about 1000 U/L; about 50 U/L to about 900 U/L; about 80 U/L to about 875 U/L; about 50 U/L to about 800 U/L; about 50 U/L to about 700 U/L; about 50 U/L to about 600 U/L; about 50 U/L to about 500 U/L; about 50 U/L to about 400 U/L; about 50 U/L to about 300 U/L; about 50 U/L to about 200 U/L; about 50 U/L to about 100 U/L; 100 U/L to about 8000 U/L; about 200 U/L to about 7000 U/L; about 300 U/L to about 6000 U/L; about 400 U/L to about 5000 U/L; about 500 U/L to about 4000 U/L; about 600 U/L to about 3000 U/L; about 700 U/L to about 2000 U/L; about 800 U/L to about 1000 U/L; about 500 U/L to about 9000 U/L; about 500 U/L to about 8000 U/L; about 500 U/L to about 7000 U/L; about 500 U/L to about 6000 U/L; about 500 U/L to about 5000 U/L; about 500 U/L to about 4000 U/L; about 500 U/L to about 3000 U/L; about 500 U/L to about 2000 U/L; about 500 U/L to about 1000 U/L; or about 600 U/L to about 900 U/L.

In some embodiments, the cleaning composition includes lactate dehydrogenase (LDH). The LDH may be present in the cleaning composition in an amount of at least about 50 U/L, at least about 60 U/L, at least about 70 U/L, at least about 80 U/L, at least about 90 U/L, at least about 100 U/L, at least about 200 U/L, at least about 300 U/L, at least about 400 U/L, at least about 500 U/L, at least about 600 U/L, at least about 700 U/L, at least about 800 U/L, at least about 900 U/L, at least about 1000 U/L, at least about 2000 U/L, at least about 3000 U/L, at least about 4000 U/L, at least about 5000 U/L, at least about 6000 U/L, or at least about 7000 U/L.

In some embodiments, the LDH is present in an amount within a range having a lower limit selected from 50 U/L, 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, and 6000 U/L, and an upper limit selected from 100 U/L, 200 U/L, 300 U/L, 400 U/L, 500 U/L, 600 U/L, 700 U/L, 800 U/L, 900 U/L, 1000 U/L, 1100 U/L, 1200 U/L, 1300 U/L, 1400 U/L, 1500 U/L, 1600 U/L, 1700 U/L, 1800 U/L, 1900 U/L, 2000 U/L, 2100 U/L, 2200 U/L, 2300 U/L, 2400 U/L, 2500 U/L, 2600 U/L, 2700 U/L, 2800 U/L, 2900 U/L, 3000 U/L, 3100 U/L, 3200 U/L, 3300 U/L, 3400 U/L, 3500 U/L, 3600 U/L, 3700 U/L, 3800 U/L, 3900 U/L, 4000 U/L, 4100 U/L, 4200 U/L, 4300 U/L, 4400 U/L, 4500 U/L, 4600 U/L, 4700 U/L, 4800 U/L, 4900 U/L, 5000 U/L, 6000 U/L, and 7000 U/L.

In some embodiments, the LDH is present in the cleaning composition in an amount of about 50 U/L to about 7000 U/L; about 50 U/L to about 6000 U/L; about 50 U/L to about 5000 U/L; about 50 U/L to about 4000 U/L; about 50 U/L to about 3000 U/L; about 50 U/L to about 2000 U/L; about 50 U/L to about 1000 U/L; about 50 U/L to about 900 U/L; about 50 U/L to about 800 U/L; about 50 U/L to about 700 U/L; about 60 U/L to about 700 U/L; about 50 U/L to about 600 U/L; about 50 U/L to about 500 U/L; about 50 U/L to about 400 U/L; about 50 U/L to about 300 U/L; about 50 U/L to about 200 U/L; about 50 U/L to about 100 U/L; 100 U/L to about 7000 U/L; about 200 U/L to about 6000 U/L; about 300 U/L to about 5000 U/L; about 400 U/L to about 4000 U/L; about 500 U/L to about 3000 U/L; about 500 U/L to about 2000 U/L; about 500 U/L to about 1000 U/L; about 600 U/L to about 900 U/L; about 600 U/L to about 800 U/L; or about 600 U/L to about 700 U/L.

In some embodiments, the cleaning composition includes:

| Component | Concentration |
|---|---|
| Lipase | from about 100 to |
| | about 16000 U/L |
| Amylase | from about 50 to |
| | about 8000 U/L |
| Pseudocholinesterase (PCHE) | from about 1 to |
| | about 200 U/mL |
| Gamma-glutamyl Transpeptidase (GGT) | from about 50 to |
| | about 9000 U/L |
| Lactate Dehydrogenase (LDH) | from about 50 to |
| | about 7000 U/L |

In some embodiments, the cleaning composition includes magnesium chloride hexahydrate. The magnesium chloride hexahydrate may be present in the cleaning composition in an amount within a range having a lower limit selected from 0.001 g/L, 0.002 g/L, 0.003 g/L, 0.004 g/L, 0.005 g/L, 0.006 g/L, 0.007 g/L, 0.008 g/L, 0.009 g/L, 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, and 5.0 g/L, and an upper limit selected from 0.002 g/L, 0.003 g/L, 0.004 g/L, 0.005 g/L, 0.006 g/L, 0.007 g/L, 0.008 g/L, 0.009 g/L, 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, 5.0 g/L, and 6.0 g/L. For example, in some embodiments, the magnesium chloride hexahydrate is present in an amount of about 0.0001 g/L to about 6.0 g/L; about 0.001 g/L to about 6.0 g/L; about 0.01 g/L to about 6.0 g/L; about 0.1 g/L to about 6.0 g/L; about 0.1 g/L to about 5.0 g/L; about 0.1 g/L to about 4.0 g/L; about 0.1 g/L to about 3.0 g/L; about 0.1 g/L to about 2.0 g/L; about 0.1 g/L to about 1.0 g/L; about 0.1 g/L to about 0.9 g/L; about 0.2 g/L to about 0.8 g/L; about 0.3 g/L to about 0.7 g/L; about 0.4 g/L to about 0.6 g/L; about 0.4 g/L to about 0.5 g/L; about 0.04 g/L to about 0.1 g/L; about 0.04 g/L to about 0.95 g/L; about 0.04 g/L to about 0.85 g/L; about 0.04 g/L to about 0.75 g/L; about 0.04 g/L to about 0.65 g/L; or about 0.04 g/L to about 0.55 g/L.

In some embodiments, the cleaning composition includes zinc chloride. The zinc chloride may be present in the cleaning composition in an amount within a range having a lower limit selected from 0.001 mg/L, 0.002 mg/L, 0.003 mg/L, 0.004 mg/L, 0.005 mg/L, 0.006 mg/L, 0.007 mg/L, 0.008 mg/L, 0.009 mg/L, 0.01 mg/L, 0.02 mg/L, 0.03 mg/L, 0.04 mg/L, 0.05 mg/L, 0.06 mg/L, 0.07 mg/L, 0.08 mg/L, 0.09 mg/L, 0.1 mg/L, 0.2 mg/L, 0.3 mg/L, 0.4 mg/L, 0.5 mg/L, 0.6 mg/L, 0.7 mg/L, 0.8 mg/L, 0.9 mg/L, 1.0 mg/L, 2.0 mg/L, 3.0 mg/L, 4.0 mg/L, 5.0 mg/L, 10 mg/L, 20 mg/L, 30 mg/L, 40 mg/L, 50 mg/L, 60 mg/L, 70 mg/L, 80 mg/L, 90 mg/L, 100 mg/L, 110 mg/L, 120 mg/L, 130 mg/L, 140 mg/L, 150 mg/L, 160 mg/L, 170 mg/L, 180 mg/L, and 190 mg/L, and an upper limit selected from 0.002 mg/L, 0.003 mg/L, 0.004 mg/L, 0.005 mg/L, 0.006 mg/L, 0.007 mg/L, 0.008 mg/L, 0.009 mg/L, 0.01 mg/L, 0.02 mg/L, 0.03 mg/L, 0.04 mg/L, 0.05 mg/L, 0.06 mg/L, 0.07 mg/L, 0.08 mg/L, 0.09 mg/L, 0.1 mg/L, 0.2 mg/L, 0.3 mg/L, 0.4 mg/L, 0.5 mg/L, 0.6 mg/L, 0.7 mg/L, 0.8 mg/L, 0.9 mg/L, 1.0 mg/L, 2.0 mg/L, 3.0 mg/L, 4.0 mg/L, 5.0 mg/L, 10 mg/L, 20 mg/L, 30 mg/L, 40 mg/L, 50 mg/L, 60 mg/L, 70 mg/L, 80 mg/L, 90 mg/L, 100 mg/L, 110 mg/L, 120 mg/L, 130 mg/L, 140 mg/L, 150 mg/L, 160 mg/L, 170 mg/L, 180 mg/L, 190 mg/L, and 200 mg/L. For example, in some embodiments, the zinc chloride may be present in an amount of about 0.001 mg/L to about 200.0 mg/L; about 0.01 m g/L to about 200.0 mg/L; about 0.1 g/L to about 200.0 mg/L; about 1.0 mg/L to about 200 mg/L; about 1.0 mg/L to about 100 mg/L; about 1.0 mg/L to about 80 mg/L; about 1.0 mg/L to about 60 mg/L; about 1.0 mg/L to about 40 mg/L; about 1.0 mg/L to about 20 mg/L; about 2.0 mg/L to about 19 mg/L; about 3.0 mg/L to about 18 mg/L; about 4.0 mg/L to about 17 mg/L; about 5.0 mg/L to about 16 mg/L; about 10.0 mg/L to about 20 mg/L; about 11.0 mg/L to about 20 mg/L; about 12.0 mg/L to about 20 mg/L; about 13.0 mg/L to about 20 mg/L; about 14.0 mg/L to about 20 mg/L; or about 15.0 mg/L to about 20 mg/L.

In some embodiments, the cleaning composition includes HEPES (acid). The HEPES (acid) may be present in the cleaning composition in an amount within a range having a lower limit selected from 0.001 g/L, 0.002 g/L, 0.003 g/L, 0.004 g/L, 0.005 g/L, 0.006 g/L, 0.007 g/L, 0.008 g/L, 0.009 g/L, 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, 5.0 g/L, 6.0 g/L, 7.0 g/L, 8.0 g/L, 9.0 g/L, 10.0 g/L, 20.0 g/L, 30.0 g/L, 40.0 g/L, 50.0 g/L, 60.0 g/L, 70.0 g/L, 80.0 g/L, 90.0 g/L, 100.0 g/L, 110.0 g/L, 120.0 g/L, 130.0 g/L, and 140.0 g/L, and an upper limit selected from 0.002 g/L, 0.003 g/L, 0.004 g/L, 0.005 g/L, 0.006 g/L, 0.007 g/L, 0.008 g/L, 0.009 g/L, 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, 5.0 g/L, 6.0 g/L, 7.0 g/L, 8.0 g/L, 9.0 g/L, 10.0 g/L, 20.0 g/L, 30.0 g/L, 40.0 g/L, 50.0 g/L, 60.0 g/L, 70.0 g/L, 80.0 g/L, 90.0 g/L, 100.0 g/L, 110.0 g/L, 120.0 g/L, 130.0 g/L, 140.0 g/L, and 150.0 g/L. For example, in some embodiments, the HEPES (acid) is present in an amount of about 0.0001 g/L to about 150.0 g/L; about 0.001 g/L to about 150.0 g/L; about 0.01 g/L to about 150.0 g/L; about 0.1 g/L to about 150.0 g/L; about 1.0 g/L to about 150.0 g/L, about 1.0 g/L to about 140.0 g/L; about 1.0 g/L to about 120.0 g/L; about 1.0 g/L to about 100.0 g/L; 1 about 1.0 g/L to about 80.0 g/L; about 1.0 g/L to about 60.0 g/L; about 1.0 g/L to about 40.0 g/L; about 1.0 g/L to about 20.0 g/L; about 1.0 g/L to about 19.0 g/L; about 1.0 g/L to about 18.0 g/L; about 1.0 g/L to about 17.0 g/L; about 1.0 g/L to about 16.0 g/L; about 1.0 g/L to about 14.0 g/L; about 1.0 g/L to about 13.0 g/L; about 1.0 g/L to about 12.0 g/L; about 1.0 g/L to about 11.0 g/L; about 10.0 g/L to about 20.0 g/L; about 10.0 g/L to about 15.0 g/L, about 10.0 g/L to about 14.0 g/L; about 10.0 g/L to about 13.0 g/L; about 10.0 g/L to about 12.0 g/L; or about 10 g/L to about 11 g/L.

In some embodiments, the cleaning composition includes sodium HEPES. The sodium HEPES may be present in the cleaning composition in an amount within a range having a lower limit selected from 0.001 g/L, 0.002 g/L, 0.003 g/L, 0.004 g/L, 0.005 g/L, 0.006 g/L, 0.007 g/L, 0.008 g/L, 0.009 g/L, 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, 5.0 g/L, 6.0 g/L, 7.0 g/L, 8.0 g/L, 9.0 g/L, 10.0 g/L, 20.0 g/L, 30.0 g/L, and 40.0 g/L, and an upper limit selected from 0.002 g/L, 0.003 g/L, 0.004 g/L, 0.005 g/L, 0.006 g/L, 0.007 g/L, 0.008 g/L, 0.009 g/L, 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, 5.0 g/L, 6.0 g/L, 7.0 g/L, 8.0 g/L, 9.0 g/L, 10.0 g/L, 20.0 g/L, 30.0 g/L, 40.0 g/L, and 50.0 g/L. For example, in some embodiments, the sodium HEPES may be present in an amount of about 0.0001 g/L to about 50.0 g/L; about 0.001 g/L to about 50.0 g/L; about 0.01 g/L to about 50.0 g/L; about 0.1 g/L to about 50.0 g/L; about 0.1 g/L to about 40.0 g/L; about 0.1 g/L to about 30.0 g/L; about 0.1 g/L to about 20.0 g/L; about 0.1 g/L to about 15.0 g/L; about 0.1 g/L to about 10.0 g/L; about 0.1 g/L to about 5.0 g/L; about 0.25 g/L to about 5.0 g/L; about 0.25 g/L to about 4.5 g/L; about 0.25 g/L to about 4.0 g/L; about 0.25 g/L to about 3.5 g/L; about 0.25 g/L to about 3.0 g/L; about 1.0 g/L to about 10.0 g/L; about 1.0 g/L to about 5.0 g/L; about 1.0 g/L to about 4.0 g/L, or about 1.0 g/L to about 3.5 g/L.

In some embodiments, the cleaning composition includes streptomycin sulfate and/or gentamicin sulfate. The streptomycin sulfate and/or gentamycin sulfate may be present in the cleaning composition in an amount within a range having a lower limit selected from 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, 5.0 g/L, 6.0 g/L, 7.0 g/L, 8.0 g/L, 9.0 g/L, 10.0 g/L, 11.0 g/L, 12.0 g/L, 13.0 g/L, 14.0 g/L, 15.0 g/L, 16.0 g/L, 17.0 g/L, 18.0 g/L, and 19.0 g/L, and upper limit selected from 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, 5.0 g/L, 6.0 g/L, 7.0 g/L, 8.0 g/L, 9.0 g/L, 10.0 g/L, 11.0 g/L, 12.0 g/L, 13.0 g/L, 14.0 g/L, 15.0 g/L, 16.0 g/L, 17.0 g/L, 18.0 g/L, 19.0 g/L, and 20.0 g/L. For example, in some embodiments, the streptomycin sulfate and/or gentamycin sulfate may be present in an amount of about 0.01 g/L to about 20.0 g/L; about 0.01 g/L to about 10.0 g/L; about 0.01 g/L to about 9.0 g/L; about 0.01 g/L to about 8.0 g/L; about 0.01 g/L to about 7.0 g/L; about 0.01 g/L to about 6.0 g/L; about 0.01 g/L to about 5.0 g/L; about 0.01 g/L to about 4.0 g/L; about 0.01 g/L to about 3.0 g/L; about 0.01 g/L to about 2.0 g/L; about 0.01 g/L to about 1.0 g/L; about 0.01 g/L to about 0.9 g/L; about 0.01 g/L to about 0.8 g/L; about 0.01 g/L to about 0.7 g/L; about 0.01 g/L to about 0.6 g/L; about 0.01 g/L to about 0.5 g/L; about 0.01 g/L to about 0.4 g/L; about 0.01 g/L to about 0.3 g/L; about 0.01 g/L to about 0.2 g/L; about 0.01 g/L to about 0.15 g/L; about 0.10 g/L to about 0.15 g/L; about 0.11 g/L to about 0.15 g/L; about 0.11 g/L to about 0.14 g/L; about 0.11 g/L to about 0.13 g/L; or about 0.11 g/L to about 0.12 g/L.

In some embodiments, the cleaning composition includes amphotericin B. The amphotericin B may be present in the cleaning composition in an amount within a range having a lower limit selected from 2.5 mg/L, 3.0 mg/L, 4.0 mg/L, 5.0 mg/L, 10 mg/L, 20 mg/L, 30 mg/L, 40 mg/L, 50 mg/L, 60 mg/L, 70 mg/L, 80 mg/L, 90 mg/L, 100 mg/L, 150 mg/L, 200 mg/L, and 250 mg/L, and an upper limit selected from 3.0 mg/L, 4.0 mg/L, 5.0 mg/L, 10 mg/L, 20 mg/L, 30 mg/L, 40 mg/L, 50 mg/L, 60 mg/L, 70 mg/L, 80 mg/L, 90 mg/L, 100 mg/L, 150 mg/L, 200 mg/L, 250 mg/L, and 300 mg/L. For example, in some embodiments, the amphotericin B may be present in an amount of about 2.5 mg/L to about 300.0 mg/L; about 2.5 mg/L to about 250.0 mg/L; about 2.5 mg/L to about 200.0 mg/L; about 2.5 mg/L to about 150.0 mg/L; about 2.5 mg/L to about 100.0 mg/L; about 2.5 mg/L to about 50.0 mg/L; about 2.5 mg/L to about 40.0 mg/L; about 2.5 mg/L to about 30.0 mg/L; about 5 mg/L to about 200.0 mg/L; about 5 mg/L to about 150.0 mg/L; about 5 mg/L to about 100.0 mg/L; about 5 mg/L to about 50.0 mg/L; about 5 mg/L to about 40.0 mg/L; about 5 mg/L to about 30.0 mg/L; about 10 mg/L to about 200.0 mg/L; about 10 mg/L to about 150.0 mg/L; about 10 mg/L to about 100.0 mg/L; about 10 mg/L to about 50.0 mg/L; about 10 mg/L to about 40.0 mg/L; about 10 mg/L to about 30.0 mg/L; about 5 mg/L to about 90.0 mg/L; about 5 mg/L to about 80.0 mg/L; about 5 mg/L to about 70.0 mg/L; or about 5 mg/L to about 60.0 mg/L.

In some embodiments, the cleaning composition includes clotrimazole. The clotrimazole may be present in the cleaning composition in an amount within a range having a lower limit selected from 1.5 mg/L, 2.0 mg/L, 3.0 mg/L, 4.0 mg/L, 5.0 mg/L, 10 mg/L, 20 mg/L, 30 mg/L, 40 mg/L, 50 mg/L, 60 mg/L, 70 mg/L, 80 mg/L, 90 mg/L, 100 mg/L, 150 mg/L, and 190 mg/L, and an upper limit selected from 2.0 mg/L, 3.0 mg/L, 4.0 mg/L, 5.0 mg/L, 10 mg/L, 20 mg/L, 30 mg/L, 40 mg/L, 50 mg/L, 60 mg/L, 70 mg/L, 80 mg/L, 90 mg/L, 100 mg/L, 150 mg/L, and 190 mg/L, and 200 mg/L. For example, in some embodiments, the clotrimazole may be present in an amount of about 1.5 mg/L to about 200.0 mg/L; about 1.5 mg/L to about 150.0 mg/L; about 1.5 mg/L to about 100.0 mg/L; about 1.5 mg/L to about 80.0 mg/L; about 1.5 mg/L to about 60.0 mg/L; about 1.5 mg/L to about 40.0 mg/L; about 1.5 mg/L to about 20.0 mg/L; about 5.0 mg/L to about 150.0 mg/L; about 5.0 mg/L to about 100.0 mg/L; about 5.0 mg/L to about 80.0 mg/L; about 5.0 mg/L to about 60.0 mg/L; about 5.0 mg/L to about 40.0 mg/L; about 10.0 mg/L to about 100.0 mg/L; about 10.0 mg/L to about 80.0 mg/L; about 10.0 mg/L to about 60.0 mg/L; about 10.0 mg/L to about 40.0 mg/L; about 10.0 mg/L to about 20.0 mg/L; about 15 mg/L to about 20.0 mg/L; about 16 mg/L to about 20.0 mg/L; about 17 mg/L to about 20.0 mg/L; about 17 mg/L to about 19.0 mg/L; or about 17 mg/L to about 18.0 mg/L.

In some embodiments, the cleaning composition includes bovine albumin. The bovine albumin may be present in the cleaning composition in an amount within a range having a lower limit selected from 0.001 g/L, 0.002 g/L, 0.003 g/L, 0.004 g/L, 0.005 g/L, 0.006 g/L, 0.007 g/L, 0.008 g/L, 0.009 g/L, 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 g/L, 0.7 g/L, 0.8 g/L, 0.9 g/L, 1.0 g/L, 2.0 g/L, 3.0 g/L, 4.0 g/L, 5.0 g/L, 10 g/L, 20 g/L, 30 g/L, 40 g/L, 50 g/L, 60 g/L, 70 g/L, 80 g/L, 90 g/L, 100 g/L, 110 g/L, 120 g/L, 130 g/L, 140 g/L, 150 g/L, 160 g/L, 170 g/L, 180 g/L, 190 g/L, 200 g/L, 300 g/L, 400 g/L, 500 g/L, 600 g/L, and 700 g/L, and an upper limit selected from 0.002 g/L, 0.003 g/L, 0.004 g/L, 0.005 g/L, 0.006 g/L, 0.007 mg/L, 0.008 g/L, 0.009 g/L, 0.01 g/L, 0.02 g/L, 0.03 g/L, 0.04 g/L, 0.05 g/L, 0.06 g/L, 0.07 g/L, 0.08 g/L, 0.09 g/L, 0.1 g/L, 0.2 g/L, 0.3 g/L, 0.4 g/L, 0.5 g/L, 0.6 mg/L, 0.7 g/L, 0.8 g/L, 0.9 g/L, 1.0 g/L, 2.0 g/L, 3.0 g/L, 4.0 g/L, 5.0 g/L, 10 g/L, 20 g/L, 30 g/L, 40 g/L, 50 g/L, 60 g/L, 70 g/L, 80 g/L, 90 g/L, 100 g/L, 110 g/L, 120 g/L, 130 g/L, 140 g/L, 150 g/L, 160 g/L, 170 g/L, 180 g/L, 190 g/L, 200 g/L, 300 g/L, 400 g/L, 500 g/L, 600 g/L, 700 g/L, and 800. g/L For example, in some embodiments, the bovine albumin may be present in an amount of about 0.001 g/L to about 800.0 g/L; about 0.01 g/L to about 800.0 g/L; about 0.1 g/L to about 800.0 g/L; about 0.1 g/L to about 500.0 g/L; about 1 g/L to about 500.0 g/L; about 1 g/L to about 250.0 g/L; about 1.0 g/L to about 100.0 g/L; about 6 g/L to about 500.0 g/L; about 6 g/L to about 250.0 g/L; about 6.0 g/L to about 100.0 g/L; about 6.0 g/L to about 95.0 g/L; about 6.0 g/L to about 90.0 g/L; about 6.0 g/L to about 85.0 g/L; about 6.0 g/L to about 80.0 g/L; about 6.0 g/L to about 75.0 g/L; about 6.0 g/L to about 70.0 g/L; about 6.0 g/L to about 65.0 g/L; about 6.0 g/L to about 60.0 g/L; about 6.0 g/L to about 50.0 g/L; about 10 g/L to about 500.0 g/L; about 10 g/L to about 250.0 g/L; about 10.0 g/L to about 100.0 g/L; about 10.0 g/L to about 90.0 g/L; about 10.0 g/L to about 80.0 g/L; about 10.0 g/L to about 70.0 g/L; about 10.0 g/L to about 60.0 g/L; about 10.0 g/L to about 50.0 g/L; about 20.0 g/L to about 100.0 g/L; about 30.0 g/L to about 100.0 g/L; about 40.0 g/L to about 100.0 g/L; about 50.0 g/L to about 100.0 g/L; about 60.0 g/L to about 100.0 g/L; about 50.0 g/L to about 90.0 g/L; about 60.0 g/L to about 90.0 g/L; about 60.0 g/L to about 80.0 g/L; about 60.0 g/L to about 70.0 g/L; or about 60.0 g/L to 75 g/L.

In some embodiments, the cleaning composition includes:

| Component | Concentration |
|---|---|
| Magnesium Chloride Hexahydrate | from about 0.001 to about 6.0 g/L |
| Zinc Chloride | from about 0.001 to about 200 mg/L |
| HEPES (acid) | from about 0.001 to about 150 g/L |
| Sodium HEPES | from about 0.001 to about 50 g/L |
| Streptomycin Sulfate | from about 0.01 to about 20 g/L |
| Gentamicin Sulfate | from about 0.01 to about 20 g/L |
| Amphotericin B | from about 2.5 to about 300 mg/L |
| Clotrimazole | from about 1.5 to about 200 mg/L |
| Bovine Albumin | from about 0.001 to about 800 g/L |

In some embodiments, the cleaning composition includes:

| Component | Concentration |
|---|---|
| Lipase | from about 150 to about 1600 U/L |
| Amylase | from about 70 to about 800 U/L |
| Pseudocholinesterase (PCHE) | from about 1 to about 20 U/mL |
| Gamma-glutamyl Transpeptidase | from about 80 to about 875 U/L |
| (GGT) | |
| Lactate Dehydrogenase (LDH) | from about 60 to about 700 U/L |
| Magnesium Chloride Hexahydrate | from about 0.04 to about 0.55 g/L |
| Zinc Chloride | from about 1 to about 20 mg/L |
| HEPES (acid) | from about 1 to about 12 g/L |
| Sodium HEPES | from about 0.25 to about 3.5 g/L |
| Streptomycin Sulfate | from about 0.01 to about 0.15 g/L |
| Gentamicin Sulfate | from about 0.01 to about 0.15 g/L |
| Amphotericin B | from about 2.5 to about 30 mg/L |
| Clotrimazole | from about 1.5 to about 20 mg/L |
| Bovine Albumin | from about 6 to about 75 g/L |

In some embodiments, the cleaning composition includes:

| Component | Concentration |
|---|---|
| Lipase | about 1562 U/L |
| Amylase | about 725 U/L |
| Pseudocholinesterase (PCHE) | about 14.7 U/mL |
| Gamma-glutamyl Transpeptidase (GGT) | about 840 U/L |
| Lactate Dehydrogenase (LDH) | about 650 U/L |
| Magnesium Chloride Hexahydrate | about 0.468 g/L |
| Zinc Chloride | about 15.7 mg/L |
| HEPES (acid) | about 10.9 g/L |
| Sodium HEPES | about 2.99 g/L |
| Streptomycin Sulfate | about 0.115 g/L |
| Gentamicin Sulfate | about 0.115 g/L |
| Amphotericin B | about 28.7 mg/L |
| Clotrimazole | about 17.68 mg/L |
| Bovine Albumin | about 69 g/L |

In some embodiments, the electrode sub-system is positioned inside a clinical or chemistry analyzer.

According to the present disclosure, the electrode sub-system can contain one or more sensors. For example, the electrode sub-system can contain one sensor, two sensors, three sensors, four sensors, or five sensors. When two or more sensors are present in the electrode sub-system, these sensors can be the same or different.

Suitable sensors that can be present in the electrode sub-system include, but are not limited to an electrolyte sensor, a gas sensor, a metabolite sensor, a potentiometric sensor, an amperometric sensor, an optical sensor, a conductivity sensor, a biosensor made of biomolecules, such as enzymes, antibodies, peptides, nucleic acids, etc, independent of the analytes or substance being measured. In one embodiment, the sensor is an ion selective sensor for sensing other species, including, but not limited to potassium ions (K⁺), sodium ions (Na⁺), chloride ions (Cl⁻), bicarbonate ions (HCO₃⁻), calcium ions (Ca²⁺), magnesium ions (Mg²⁺), ammonium (NH₄⁺), and/or pH levels.

The integrated multisensor technology (IMT) system always creates a pattern of fluid and air slugs in the IMT manifold when processing samples or IMT standard A and standard B during calibration. There is an air pad on each multisensor cartridge to generate signals for the air slugs. The air read signals are based on conductivity measurement.

As samples are processed over time, buildup (protein, lipids, etc) can be formed in the IMT system, including the manifold, tubing, and/or sensor cartridge. Coatings of buildup change the surface of the air pad and impact the conductivity measurements. IMT cleanliness related calibration failures are often observed with significantly reduced air reads with noticeably decreased K slopes. Such as K slopes that are lower than 50 mV/dec.

Every sensor has a use lifetime (sensor in-use life) during which the calibrations of the sensor remain within the acceptance criteria (sensor is performing without calibration failures). Near the end of the use lifetime of the sensor, significantly reduced air reads and/or noticeably decreased K slopes are observed.

In some embodiments, the use of the cleaning composition to clean the electrode sub-system extends the use lifetime for the sensor. In some embodiments, the use of the cleaning composition to clean the electrode sub-system results in bring the air reads back to the baseline. In some embodiments, the use of the cleaning composition to clean the electrode sub-system results in increase of the K slopes.

In some embodiments, the use time for the sensor for at least 1 day, at least 2 days, at least 3 days, at least 4 days, at least 5 days, at least 6 days, at least 7 days, at least 8 days, at least 9 days, at least 10 days, at least 11 days, at least 12 days, at least 13 days, at least 14 days, at least 15 days, at least 16 days, at least 17 days, at least 18 days, at least 19 days, at least 20 days, at least 21 days, at least 22 days, at least 23 days, at least 24 days, at least 25 days, at least 26 days, at least 27 days, at least 28 days, at least 29 days, at least 30 days, at least 2 months, at least 3 months, at least 4 months, or more.

In some embodiments, the fluid flow channel comprises one or more of tubing or passages in a manifold.

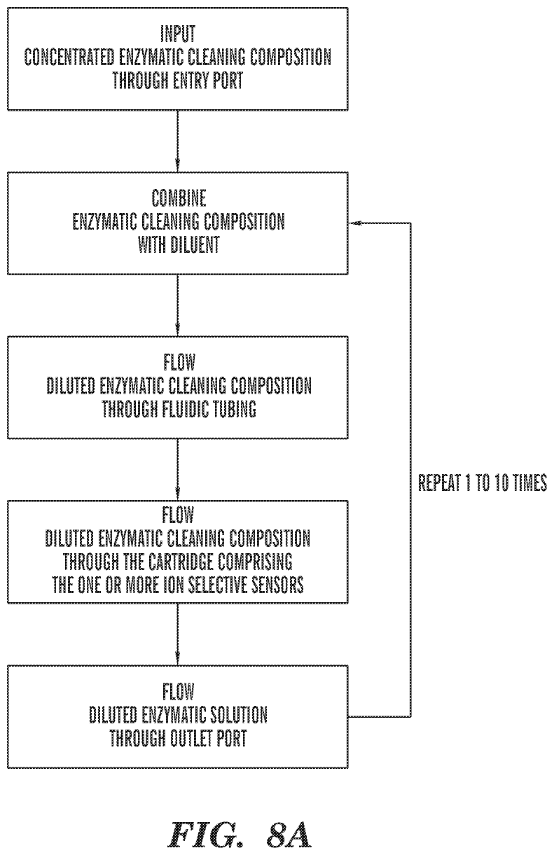

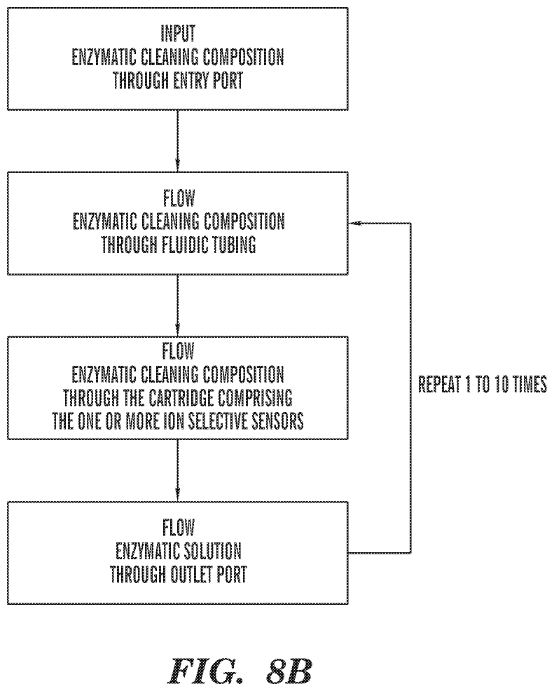

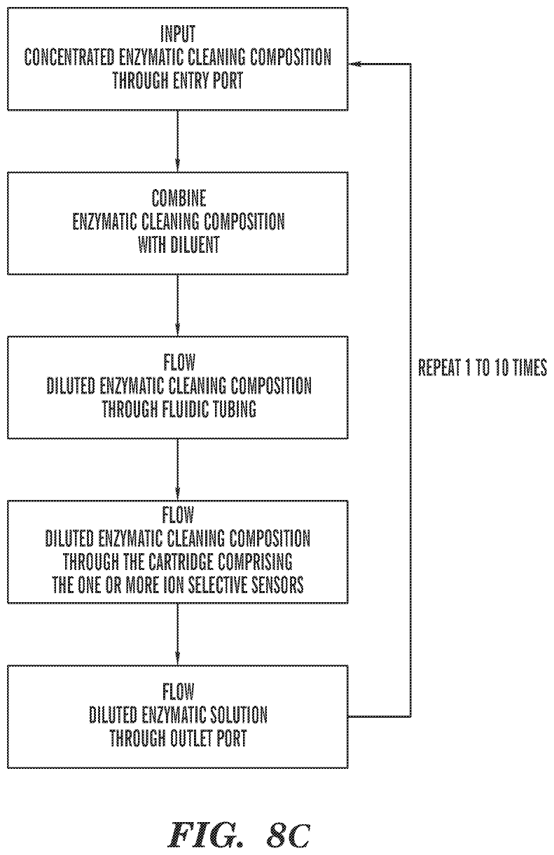

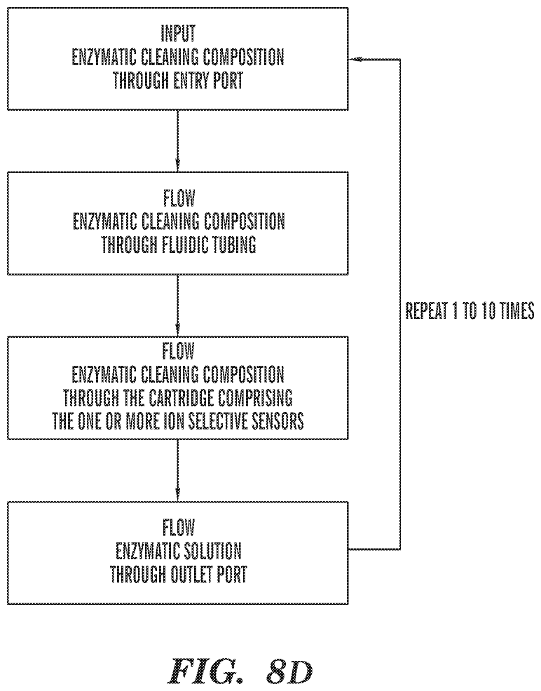

In some examples, the technology described and illustrated herein includes a method of cleaning an electrode sub-system within a chemistry analyzer system. The sub-system in some examples includes an inlet port, one or more sensors, an outlet port, and/or a fluid flow channel connecting the inlet port, one or more sensors, and the outlet port, although the sub-system can include other components in other examples. The sub-system is also referred to herein as an integrated multisensor technology (IMT) system. The cleaning can include generating or providing a cleaning composition or solution that includes one or more cleaning enzymes (e.g., amylase and/or lipase), one or more pH modulators, one or more matrix components, one or more buffer components, and/or one or more preservatives. In some examples, the sensor is an ion selective sensor. The cleaning composition is also referred to herein as A-LYTE® IMT Cleaner, and can have a pH range of from about 7.2 to about 7.4, although other pHs can also be used in other examples. In some examples, the cleaning is conducted as shown in FIGS. 8A-8D.

The cleaning can further include flowing the cleaning composition through the sub-system and/or flowing a rinsing solution through the sub-system. The flowing of the rinsing solution is effective to remove any residual cleaning composition from the sub-system. Additionally, the cleaning can include calibrating the sensor to prepare for subsequent sample analysis. The following Examples are presented to illustrate various aspects of the present technology but are not intended to limit the scope of the claimed technology.

The following is a list of non-limiting illustrative embodiments disclosed herein:

Illustrative embodiment 1. A method of cleaning an electrode sub-system, said method comprising: (a) providing a cleaning composition comprising: (i) one or more cleaning enzymes; (ii) one or more pH modulators; (iii) one or more matrix components: (iv) one or more buffer components; and (v) one or more preservatives, wherein said cleaning composition has a pH range of from about 7.2 to about 7.4; and (b) flowing the cleaning composition through the electrode sub-system, wherein the electrode sub-system comprises an inlet port, one or more sensors, an outlet port, and a fluid flow channel connecting said inlet port, said one or more sensors, and said outlet port.

Illustrative embodiment 2. The method of illustrative embodiment 1, further comprising: (c) flowing a rinsing solution through the electrode sub-system, wherein said flowing a rinsing solution is effective to remove any residual cleaning composition from the electrode sub-system.

Illustrative embodiment 3. The method of any one of illustrative embodiments 1-2, wherein said cleaning composition is substantially free of sodium hypochlorite.

Illustrative embodiment 4. The method of any one of illustrative embodiments 1-3, wherein said one or more cleaning enzymes is selected from the group consisting of an amylase, a lipase, and combinations thereof.

Illustrative embodiment 5. The method of any one of illustrative embodiments 1-4, wherein the one or more pH modulators is selected from the group consisting of hydrochloric acid, sodium hydroxide, potassium hydroxide, calcium hydroxide, phosphoric acid, tetramethylammonium hydroxide, CAPSO free acid, citric acid, acetic acid. CHES, borate, and combination thereof.

Illustrative embodiment 6. The method of any one of illustrative embodiments 1-5, wherein said one or more matrix components is selected from the group consisting of bovine serum albumin, human serum albumin, zinc chloride, and magnesium chloride hexahydrate.

Illustrative embodiment 7. The method of any one of illustrative embodiments 1-6, wherein said one or more buffer components is selected from the group consisting of HEPES Free Acid, HEPES Na Salt, phosphate, Tris, TES, MOPS, PIPES, TAPS, Bicine, Tricine, CAPSO. Cacodylate, and MES.

Illustrative embodiment 8. The method of any one of illustrative embodiments 1-7, wherein said one or more preservatives is selected from the group consisting of streptomycin sulfate, gentamycin sulfate, amphotericin B, clortrimazole, chloramphenicol, ampicillin, neomycin sulfate, isothiazolinones, and sodium gallate.

Illustrative embodiment 9. The method of any one of illustrative embodiments 1-8, wherein said cleaning composition further comprises a diluent.

Illustrative embodiment 10. The method of illustrative embodiments 9, wherein said diluent is selected from the group consisting of water, a buffer, a saline-based solution, a preservative, a pH modulator, and albumin.

Illustrative embodiment 11. The method of any one of illustrative embodiments 1-10, further comprising: (d) calibrating the sensor.

Illustrative embodiment 12. A method of cleaning an electrode sub-system, said method comprising: (a) providing a cleaning composition comprising: (i) lipase; (ii) amylase; (iii) one or more pH modulators selected from hydrochloric acid and sodium hydroxide; (iv) one or more matrix components selected from the group consisting of bovine serum albumin, zinc chloride, and magnesium chloride hexahydrate; (v) HEPES buffer; and (vi) one or more preservatives selected from the group consisting of streptomycin sulfate, gentamicin sulfate, amphotericin B, and clotrimazole; wherein said cleaning composition has a pH range of from about 7.2 to about 7.4; and (b) flowing the cleaning composition through the electrode sub-system, wherein the electrode sub-system comprises an inlet port, one or more sensors, an outlet port, and a fluid flow channel connecting said inlet port, said one or more sensors, and said outlet port.

Illustrative embodiment 13. The method of illustrative embodiments 12, further comprising: (c) flowing a rinsing solution through the electrode sub-system, wherein said flowing a rinsing solution is effective to remove any residual cleaning composition from the electrode sub-system.

Illustrative embodiment 14. The method of any one of illustrative embodiments 12-13, wherein said cleaning composition further comprises a diluent.

Illustrative embodiment 15. The method of illustrative embodiment 14, wherein said diluent is selected from the group consisting of water, a buffer, a saline-based solution, a preservative, a pH modulator, and albumin.

Illustrative embodiment 16. The method of any one of illustrative embodiments 12-15, further comprising: (d) calibrating the sensor.

Illustrative embodiment 17. The method of any one of illustrative embodiments 1-16, wherein the amylase is present in the cleaning composition in an amount of at least 60 U/L.

Illustrative embodiment 18. The method of any one of illustrative embodiments 1-17, wherein the lipase is present in the cleaning composition in an amount of at least 100 U/L.

Illustrative embodiment 19. The method of any one of illustrative embodiments 12-16, wherein the cleaning composition comprises:

| Component | Concentration |
|---|---|
| Lipase | from about 100 to about 16000 U/L |
| Amylase | from about 50 to about 8000 U/L |
| Pseudocholinesterase (PCHE) | from about 1 to about 200 U/mL |
| Gamma-glutamyl Transpeptidase | from about 50 to about 9000 U/L |
| (GGT) | |
| Lactate Dehydrogenase (LDH) | from about 50 to about 7000 U/L |

Illustrative embodiment 20. The method of any one of illustrative embodiments 12-16, wherein the cleaning composition comprises:

| Component | Concentration |
|---|---|
| Lipase | from about 150 to about 1600 U/L |
| Amylase | from about 70 to about 800 U/L |
| Pseudocholinesterase (PCHE) | from about 1 to about 20 U/mL |
| Gamma-glutamyl Transpeptidase | from about 80 to about 875 U/L |
| (GGT) | |
| Lactate Dehydrogenase (LDH) | from about 60 to about 700 U/L |
| Magnesium Chloride Hexahydrate | from about 0.04 to about 0.55 g/L |
| Zinc Chloride | from about 1 to about 20 mg/L |
| HEPES (acid) | from about 1 to about 12 g/L |
| Sodium HEPES | from about 0.25 to about 3.5 g/L |
| Streptomycin Sulfate | from about 0.01 to about 0.15 g/L |
| Gentamicin Sulfate | from about 0.01 to about 0.15 g/L |
| Amphotericin B | from about 2.5 to about 30 mg/L |
| Clotrimazole | from about 1.5 to about 20 mg/L |
| Bovine Albumin | from about 6 to about 75 g/L |

Illustrative embodiment 21. The method of any one of illustrative embodiments 12-16, wherein the cleaning composition comprises:

| Component | Concentration |
|---|---|
| Lipase | about 1562 U/L |
| Amylase | about 725 U/L |
| Pseudocholinesterase (PCHE) | about 14.7 U/mL |
| Gamma-glutamyl Transpeptidase (GGT) | about 840 U/L |
| Lactate Dehydrogenase (LDH) | about 650 U/L |
| Magnesium Chloride Hexahydrate | about 0.468 g/L |
| Zinc Chloride | about 15.7 mg/L |
| HEPES (acid) | about 10.9 g/L |
| Sodium HEPES | about 2.99 g/L |
| Streptomycin Sulfate | about 0.115 g/L |
| Gentamicin Sulfate | about 0.115 g/L |
| Amphotericin B | about 28.7 mg/L |
| Clotrimazole | about 17.68 mg/L |
| Bovine Albumin | about 69 g/L |

Illustrative embodiment 22. The method of any one of illustrative embodiments 1-21, wherein the electrode sub-system is positioned inside a clinical or chemistry analyzer.

Illustrative embodiment 23. The method of any one of illustrative embodiments 1-22, wherein each of the one or more sensors present in the electrode sub-system have a use life time and wherein the use of the cleaning composition to clean the electrode sub-system extends the use life time for the sensor.

Illustrative embodiment 24. The method of any one of illustrative embodiments 1-23, wherein the sensor is an ion selective sensor.

Illustrative embodiment 25. The method of any one of illustrative embodiments 1-24, wherein the fluid flow channel comprises one or more of tubing or passages in a manifold.

### EXAMPLES

### Example 1—Materials

A-LYTE® Integrated Multisensor (IMT Na K Cl), A-LYTE® IMT Standard A, A-LYTE® IMT Standard B+Salt Bridge, and A-LYTE® IMT Diluent.

The composition of the A-LYTE® IMT Cleaner product is shown in Table 1 below:

TABLE 1

| Component | Concentration | |
|---|---|---|
| Lipase | 1562 | U/L |
| Amylase | 725 | U/L |
| Pseudocholinesterase (PCHE) | 14.7 | U/mL |
| Gamma-glutamyl Transpeptidase (GGT) | 840 | U/L |
| Lactate Dehydrogenase (LDH) | 650 | U/L |
| Magnesium Chloride Hexahydrate | 0.468 | g/L |
| Zinc Chloride | 15.7 | mg/L |
| HEPES (acid) | 10.9 | g/L |
| Sodium HEPES | 2.99 | g/L |
| Streptomycin Sulfate | 0.115 | g/L |
| Gentamicin Sulfate | 0.115 | g/L |
| Amphotericin B | 28.7 | mg/L |
| Clotrimazole | 17.68 | mg/L |
| Bovine Albumin | 69 | g/L |

The Atellica® CH system was composed of either a Direct Load (DL) or a Sample Handler (SH) connected to a Clinical Chemistry (CH) module.

### Example 2—IMT System Cleanliness and Calibration Stability

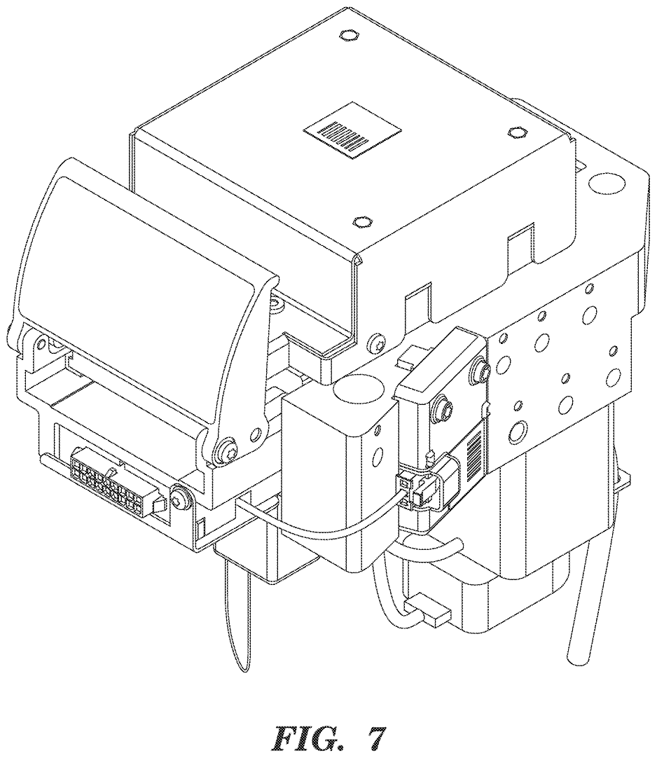

The IMT system always creates a pattern of fluid and air slugs in the IMT manifold (FIG. 7) when processing samples or IMT standard A and standard B during calibration. There is an air pad on each multisensor cartridge to generate signals for the air slugs. The air read signals are based on conductivity measurement.

As samples are processed over time, buildup (protein, lipids, etc) can be formed in the IMT system, including the manifold, tubing, and sensor cartridge. Coatings of buildup change the surface of the air pad and impact the conductivity measurements. It has to be noted that IMT cleanliness related calibration failures are always observed as significantly reduced air reads with sometimes noticeably decreased K slopes.

### Example 3—Cleaning Effects of Enzymes

Reagents: A-LYTE® Integrated Multisensor (IMT Na K Cl).

Sensor in-use life was tested by sensors onboard for 14 days or 5000 samples. Calibrations automatically occur every 4 hours or every 250 samples, whichever comes first. A successful use life was shown as the calibrations remaining within their acceptance criteria over the study duration:
Na slopes: 50-63 mV/dec;
K slopes: 50-63 mV/dec:
Cl slopes: (−40)-(−60) mV/dec; and
Standard A and Standard B air readings: ≥0.45 V.

Some immunoassay and clinical chemistry analyzers, such as Atellica® CH Analyzers, are currently being cleaned using harsh cleaners (e.g., sodium hypochlorite or bleach). These harsh cleaners are known to harm IMT sensors. Thus, in order to find alternative cleaning solutions for IMT sensors, effectiveness of enzymes for cleaning IMT sensors and chemistry analyzers was studied.

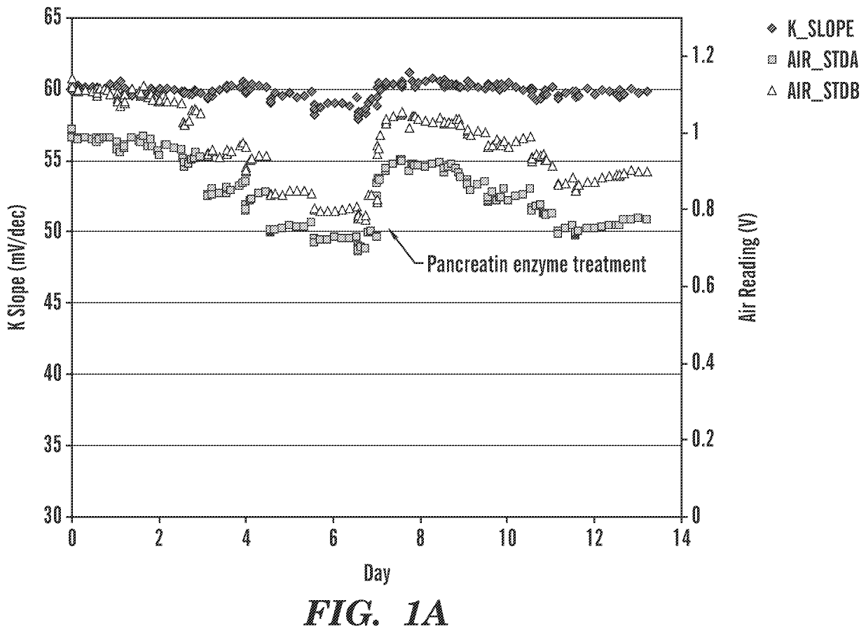

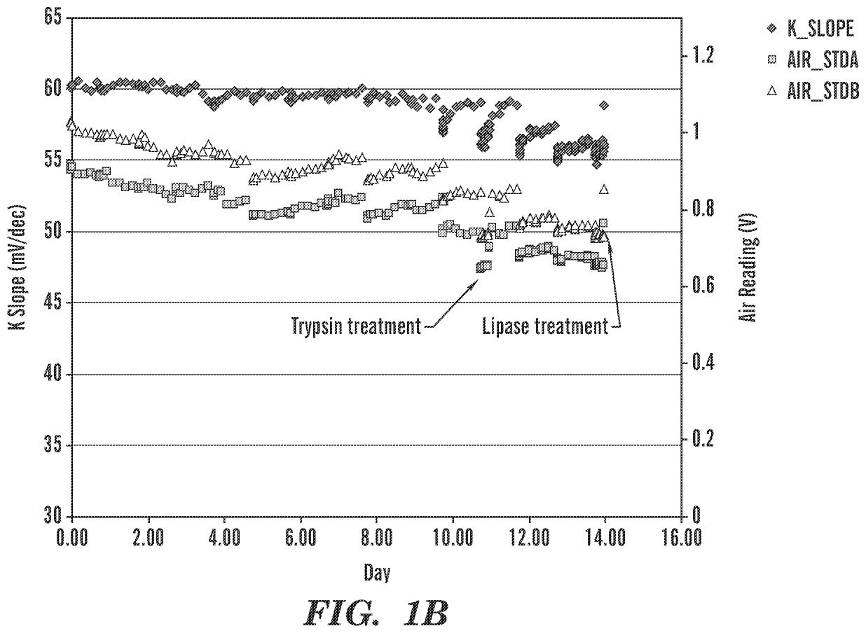

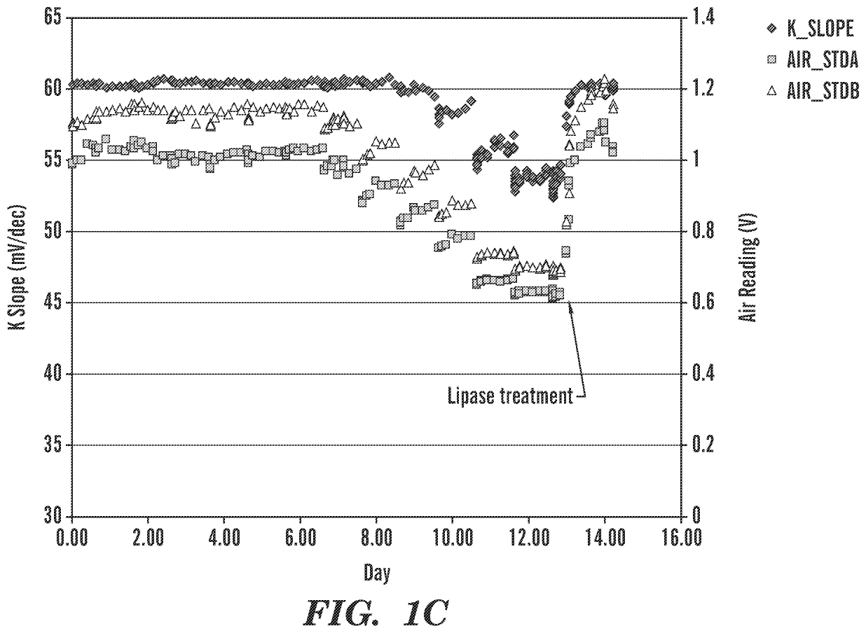

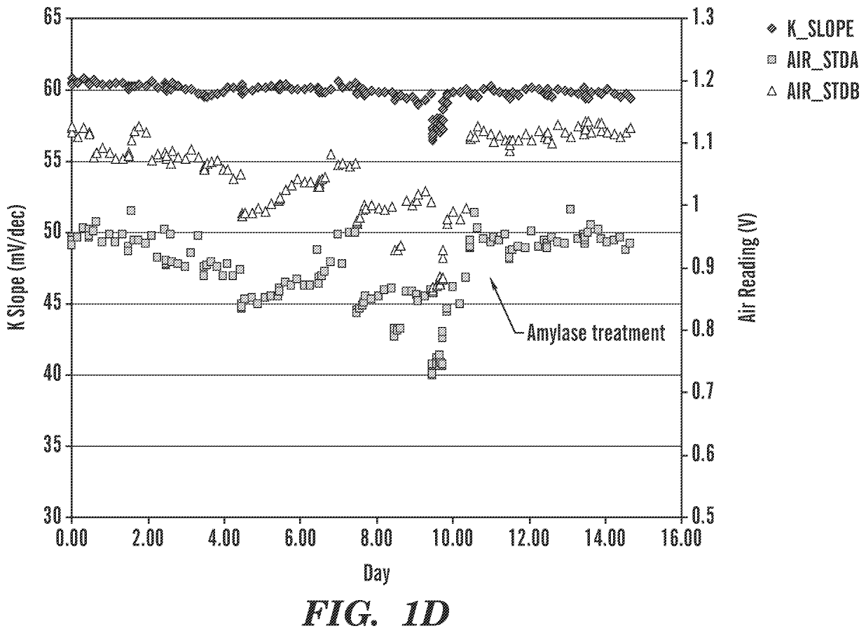

It was discovered that pancreatin from porcine pancreas could effectively bring the air reads back to the baseline and sometimes increase the K slopes if there was any reduction due to carryover. As shown in FIG. 1A, the air reads of both standard A and standard B kept decreasing with the pattern of steeping down. K slopes decreased together with the air reads and triggered K drift errors on day 8. After treatment of 17 mg/mL pancreatin solution by running as sample of 10 replicates both air reads and K slopes getting back to higher levels. To identify the effective enzymes in the pancreatin enzyme mixture, trypsin, lipase, and amylase from porcine pancreas were selected. FIGS. 1B-1D show that when tested individually both lipase and amylase exhibited similar effects of cleaning the IMT system while trypsin was not as effective as the other two.

### Example 4—A-LYTE® IMT Cleaner

Reagents: A-LYTE® Integrated Multisensor (IMT Na K Cl). Samples: Bio-Rad Liquid Assayed Multiqual (86901, 86903) and Bio-Rad Liquicheck Urine Chemistry Control (68561, 68562).

Sensor in-use life was tested by sensors onboard for 14 days or 5000 samples. The A-LYTE® IMT Cleaner was used to clean the instrument and demonstrate extended onboard stability for some sensors (>14 days or >5000 samples). A successful use life was shown as the calibrations remaining within their acceptance criteria over the study duration:
Na slopes: 50-63 mV/dec;
K slopes: 50-63 mV/dec;
Cl slopes: (−40)-(−60) mV/dec; and
Standard A and Standard B air readings: ≥0.45 V.

Sensor in-use life stability was evaluated. Each test day, one run was performed and N=5 replicates were collected on each test sample. Quality control (QC) materials were used as samples during the study. Each testing day, new aliquots were thawed. Over the duration of the study, plasma and serum samples were loaded onto the instrument in order to increase the overall number of total tests performed by the sensor. QC materials were handled according to manufacturer's instructions. Mean results were evaluated with Minitab 18 for statistically significant drift over the use-life using linear regression (result vs time). For linear regression, slopes with p-values which ≥0.05 are considered as a “Pass” result and there is no significant drift. For linear regression slopes with p-values <0.05, achieved use-life time was estimated from the bisection of the confidence Interval of the linear regression fit and the time where the allowable bias was exceeded.

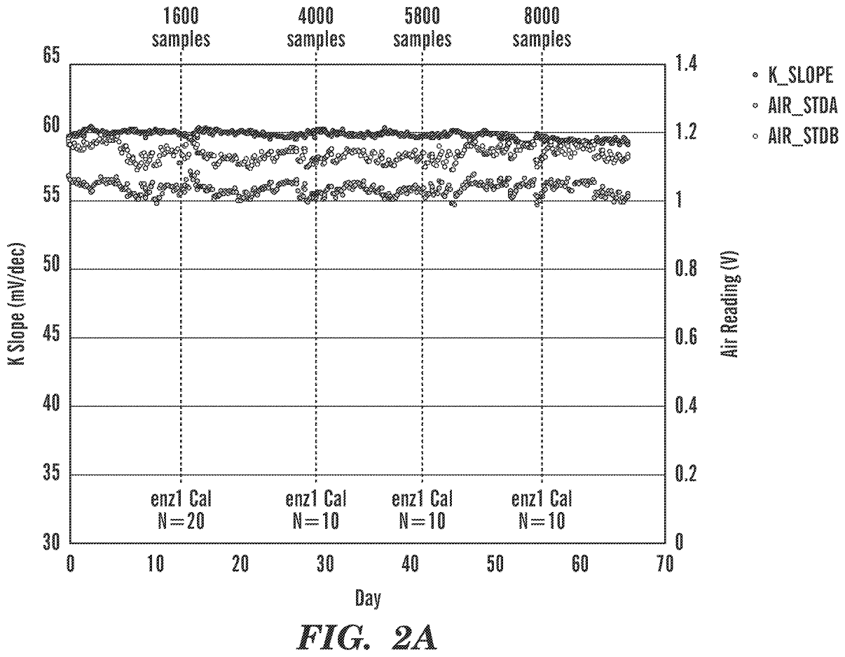

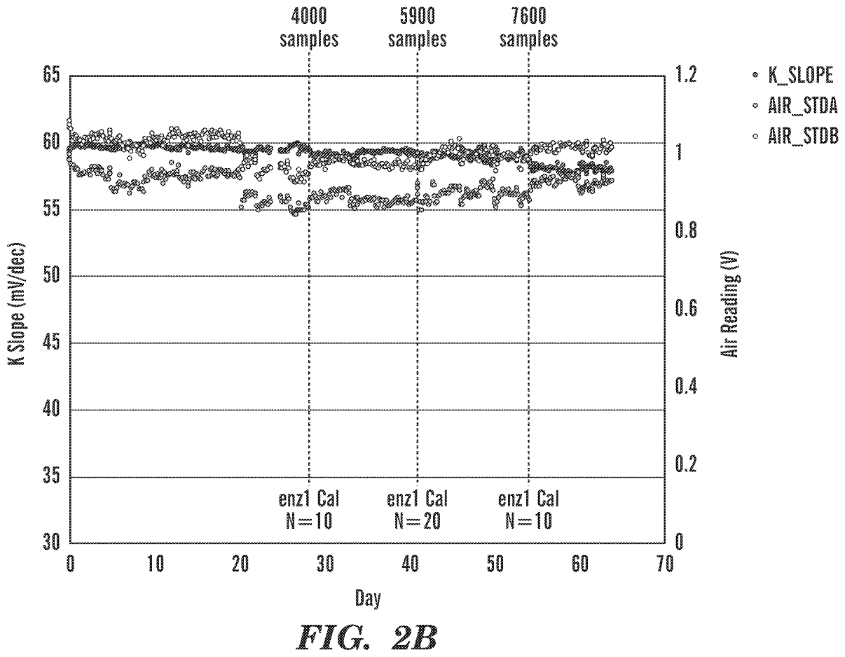

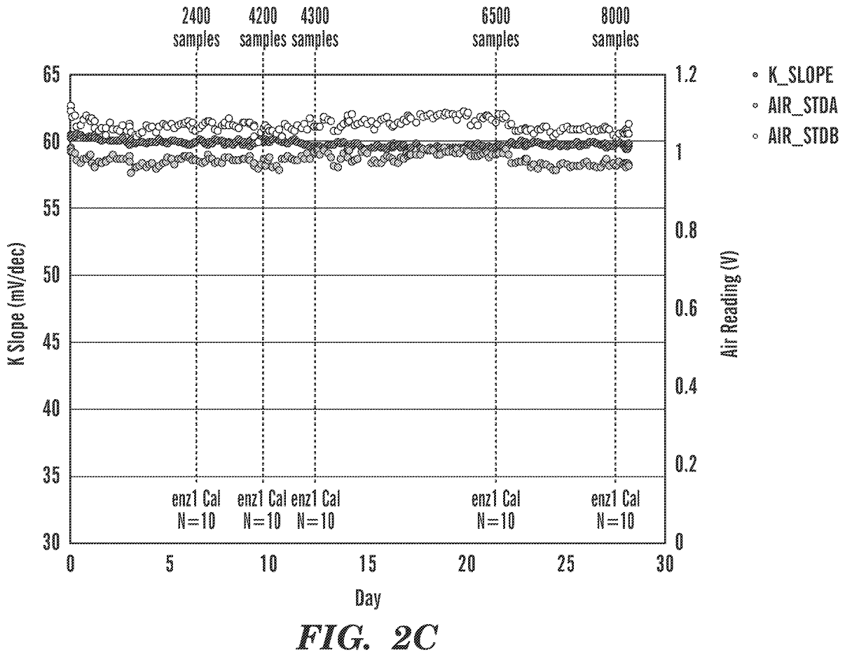

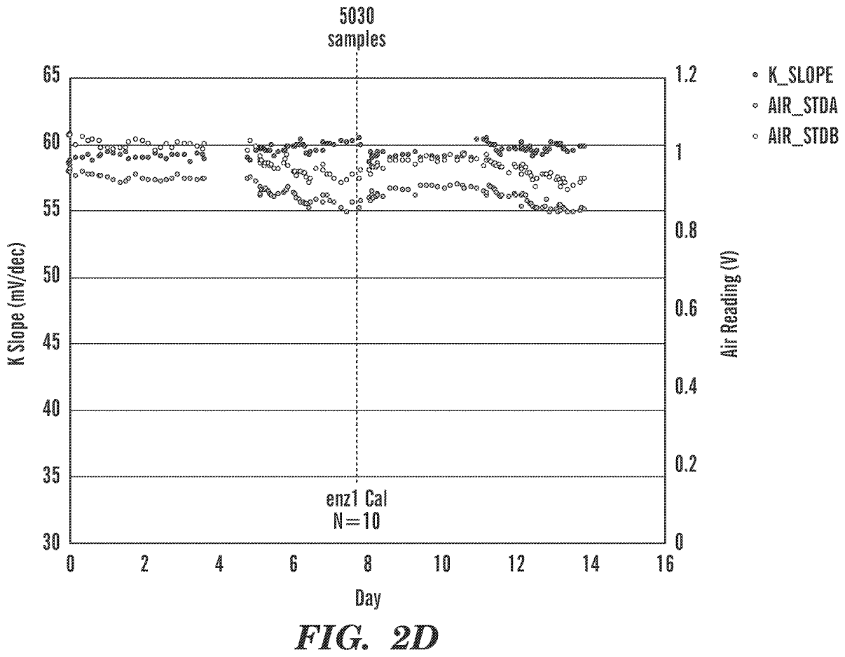

FIGS. 2A-2B show the calibration stability of air reads and K slopes of two sensors with mid-volume testing that had A-LYTE® IMT Cleaner perform as the enzyme cleaner over the sensor life of approximately two months. The sensor in FIG. 2A was cleaned roughly every two weeks and had stable air reads over the sensor life span. The sensor in FIG. 2B had the first enzyme clean on day 28 and there was some degradation of air reads observed before the first cleaning. After the first enzyme clean, air reads slightly improved. With the next routine enzyme clean events, air reads further improved, getting close to the original values of the beginning of the sensor life.

In the two studies, A-LYTE® IMT Cleaner was run as a sample with either 10 or 20 replicates. There was not a noticeable difference with an increased number of replicates from 10 to 20. FIG. 2C shows the calibration stability of air reads and K slopes of a sensor with high volume testing that had enzyme clean performed roughly every week and demonstrated 28 onboard stability and more than 8000 samples. A-LYTE® IMT Cleaner was run as samples with 10 replicates each time. FIG. 2D shows the calibration stability of air reads and K slopes of a sensor with very high-volume testing by running overnight plasma samples. Enzyme clean was performed after 5000 sample and was able to maintain a clean IMT system for the sensor to be onboard longer with nearly 10,000 samples tested. A-LYTE® IMT Cleaner was run as a sample with 10 replicates. Table 2 summarizes some additional sensors that were tested with different onboard days and sample volumes and had different frequency of enzyme clean activities. All demonstrated extended sensor onboard stability, in terms of both onboard days and number of tested samples.

TABLE 2
A Summary of Additional Sensor Calibration Stability
Study with A-LYTE ® IMT Cleaner

| Sensor | Sensor | Onboard | Number of | |
|---|---|---|---|---|
| lot | sequence | days | samples | Enzyme clean protocol |
| 100001 | 07115 | 28 | 8400 | Running as sample, N = 10, every week |
| 100001 | 02183 | 11 | 9400 | Running as sample, N = 10, every 5000 samples |
| 100002 | 01303 | 16 | 9300 | Running as sample, N = 10, every 5000 samples |
| 201115 | 00038 | 26 | 3800 | Running as sample, N = 8, every other week |

QC regression analysis was performed to evaluate if there was any impact from periodic enzyme clean on sample results. QC recoveries were stable over the life span of 28 days (Table 3), confirming the feasibility of extending the sensor use life with enzyme clean as the preventative treatment.

TABLE 3
QC Regression Analysis of Sensor #3394 of Lot 100001 over Sensor Use Life

| | Na (mmol/L) | | | | K (mmol/L) | | | | Cl (mmol/L) | | | |
|---|---|---|---|---|---|---|---|---|---|---|---|---|
| | Na | Na | Na | Na | K | K | K | K | Cl | Cl | Cl | Cl |
| | Serum | Serum | Urine | Urine | Serum | Serum | Urine | Urine | Serum | Serum | Urine | Urine |
| Day | Low | High | Low | High | Low | High | Low | High | Low | High | Low | High |
| 0 | 116 | 157 | 84.4 | 173 | 2.58 | 7.45 | 32.2 | 75.7 | 79.9 | 120 | 102 | 191 |
| 1 | 114 | 156 | 84.0 | 175 | 2.56 | 7.41 | 32.2 | 74.8 | 80.7 | 121 | 103 | 190 |
| 2 | 114 | 154 | 85.8 | 174 | 2.55 | 7.39 | 32.2 | 75.2 | 80.7 | 121 | 103 | 190 |
| 3 | 116 | 158 | 86.1 | 176 | 2.54 | 7.38 | 32.1 | 75.2 | 79.5 | 120 | 102 | 190 |
| 6 | 116 | 157 | 85.9 | 176 | 2.52 | 7.34 | 32.2 | 75.9 | 79.5 | 120 | 102 | 191 |
| 7 | 116 | 157 | 85.8 | 176 | 2.53 | 7.34 | 32.2 | 75.7 | 79.6 | 120 | 101 | 190 |
| 8 | 116 | 158 | 86.3 | 177 | 2.53 | 7.38 | 32.3 | 76.1 | 79.7 | 121 | 102 | 192 |
| 9 | 116 | 157 | 86.5 | 175 | 2.59 | 7.44 | 32.5 | 76.3 | 81.5 | 121 | 104 | 191 |
| 10 | 114 | 155 | 85.4 | 173 | 2.54 | 7.36 | 32.1 | 75.4 | 80.5 | 120 | 102 | 188 |
| 13 | 113 | 153 | 85.5 | 174 | 2.55 | 7.33 | 31.9 | 75.3 | 81.0 | 120 | 102 | 189 |
| 14 | 115 | 154 | 85.8 | 173 | 2.55 | 7.41 | 31.9 | 75.6 | 80.9 | 121 | 102 | 189 |
| 16 | 115 | 157 | 85.3 | 176 | 2.51 | 7.28 | 31.9 | 75.2 | 79.2 | 119 | 101 | 189 |
| 17 | 117 | 159 | 86.4 | 177 | 2.55 | 7.52 | 32.2 | 75.8 | 80.4 | 121 | 102 | 190 |
| 20 | 114 | 156 | 84.2 | 177 | 2.52 | 7.32 | 31.9 | 75.0 | 79.9 | 120 | 101 | 188 |
| 23 | 114 | 158 | 85.9 | 176 | 2.56 | 7.47 | 32.6 | 75.3 | 81.5 | 121 | 103 | 187 |
| 24 | 115 | 157 | 84.5 | 177 | 2.58 | 7.43 | 32.3 | 75.9 | 82.5 | 122 | 103 | 188 |
| 28 | 116 | 158 | 85.8 | 177 | 2.57 | 7.44 | 32.3 | 76.6 | 82.1 | 122 | 101 | 188 |
| upper | 120 | 162 | 88.6 | 182 | 2.71 | 7.82 | 33.9 | 79.5 | 83.9 | 126 | 107 | 201 |
| limit | | | | | | | | | | | | |
| lower | 113 | 153 | 80.1 | 165 | 2.45 | 7.08 | 30.6 | 71.9 | 75.9 | 114 | 97.2 | 181 |
| limit | | | | | | | | | | | | |
| p value | 0.740 | 0.527 | 0.911 | 0.079 | 0.838 | 0.482 | 0.981 | 0.245 | 0.016 | 0.192 | 0.489 | 0.001 |
| Observed | 28 | 28 | 28 | 28 | 28 | 28 | 28 | 28 | 40 | 28 | 28 | 59 |
| uselife | | | | | | | | | | | | |
| (days) | | | | | | | | | | | | |

### Example 5—Stress Test and Carryover Study

Reagents: A-LYTE® Integrated Multisensor (IMT Na K Cl). Samples: Bio-Rad Liquid Assayed Multiqual (86901, 86903) and Bio-Rad Liquicheck Urine Chemistry Control (68561, 68562).

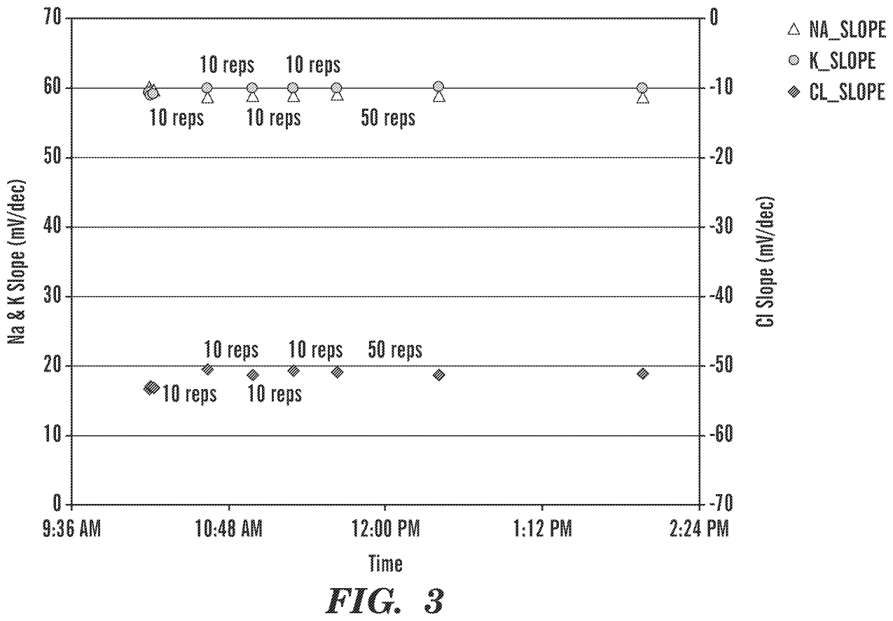

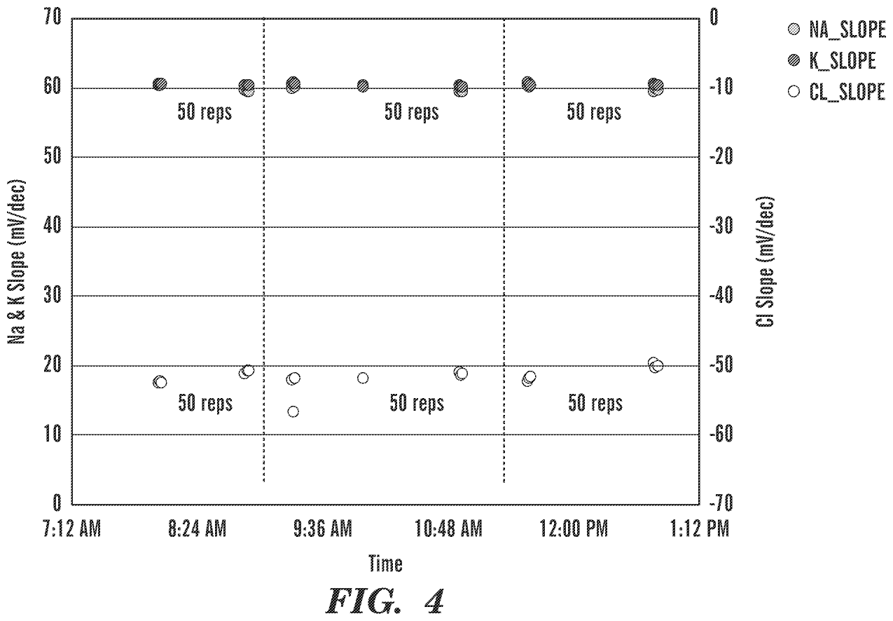

To evaluate any potential negative effect on the sensors, a stress test was carried out by running extensive A-LYTE® IMT Cleaner. FIG. 3 shows stable calibration slopes of Na, K, and Cl with total of 90 replicates of the enzyme cleaner within 3 hours. Tests on three more sensor cartridges were performed with 50 replicates on each sensor cartridge, and all Na, K, and Cl remained stable and showed healthy slopes after stressed enzyme cleaning (FIG. 4).

QC samples were run right after the enzyme clean to assess if the cleaning could cause any carryover issues. Five replicates of each QC sample were run after the cleaning. The result of the very first replicate was compared with the mean of the rest four replicates. The first replicate of each level of each analyte was well within the 3SD range of the data set (Table 4), suggesting no carryover observed right after enzyme clean.

TABLE 4
QC Recoveries After Treatment with A-LYTE ® IMT Cleaner

| | Na | | | | K | | | | Cl | | | |
|---|---|---|---|---|---|---|---|---|---|---|---|---|
| | Serum | Serum | Urine | Urine | Serum | Serum | Urine | Urine | Serum | Serum | Urine | Urine |
| | Low | High | Low | High | Low | High | Low | High | Low | High | Low | High |
| rep 1 | 115 | 157 | 84.7 | 172 | 2.57 | 7.36 | 31.1 | 73.0 | 78.7 | 120 | 101 | 192 |
| rep 2 | 116 | 158 | 84.0 | 173 | 2.59 | 7.39 | 31.4 | 73.8 | 78.1 | 119 | 100 | 192 |
| rep 3 | 115 | 157 | 84.5 | 174 | 2.58 | 7.41 | 31.4 | 74.1 | 78.7 | 120 | 100 | 190 |
| rep 4 | 115 | 158 | 84.5 | 175 | 2.59 | 7.40 | 31.4 | 74.1 | 78.6 | 119 | 100 | 191 |
| rep 5 | 116 | 158 | 84.0 | 174 | 2.60 | 7.39 | 31.4 | 74.0 | 78.7 | 119 | 100 | 191 |
| mean of | 115 | 158 | 84.2 | 174 | 2.59 | 7.40 | 31.4 | 74.0 | 78.5 | 120 | 100 | 191 |
| rep 2 to | | | | | | | | | | | | |
| rep 5 | | | | | | | | | | | | |
| Allowable | 114 | 157 | 83.2 | 171 | 2.56 | 7.34 | 31.0 | 72.6 | 77.8 | 118 | 98.4 | 188 |
| range | to | to | to | to | to | to | to | to | to | to | to | to |
| (mean of | 117 | 159 | 85.2 | 176 | 2.62 | 7.45 | 31.8 | 75.3 | 79.3 | 121 | 102 | 194 |
| rep 2 to | | | | | | | | | | | | |
| 5 ± 3SD | | | | | | | | | | | | |

This disclosure provides data that supports using enzymes as cleaning agents in the IMT system. When tested individually, lipase and amylase from porcine pancreatin showed excellent cleaning effects.

### Example 6—Storage Temperature and Shelf Life Stability of A-LYTE® IMT Cleaner

Amylase catalyzes the hydrolysis of carbohydrates to simple sugars. Lipase catalyzes the hydrolysis of fats to fatty acids and glycerol. The active enzymes in the A-LYTE® IMT Cleaner include amylase and lipase.

Shelf-life stability studies were conducted to determine the expiration dating for product in its final customer packaging. Shelf-life encompasses the interval from product manufacture, through storage under recommended conditions, until the last day of use. For this analysis, the shelf-life stability was determined by calculating the linear regression for each analyte, if the p-value for the regression slope was not significant (>0.05) then the stability was determined as the second to the last day of the study. If the p-value for the regression slope was significant (≤0.05) then the observed drift was compared to the acceptance criteria.

The Dimension Amylase and Dimension Lipase assays were calibrated with calibrators stored at −70° C. to ensure that the test calibrator (stored refrigerated at 2-8° C.) drift is dissociated from analytical system drift. Lots 5DD073 (Table 5), 5KD042 (Table 6), and 6GD078 (Table 7) represent the final formulation design of this calibrator and have been used to establish real time shelf life. The data generated for the three validation lots was adequate to support a 12 month shelf life for the A-LYTE® IMT Cleaner.

TABLE 5
Lot 5DD073

| | Level B Amylase | | Level B Lipase |
|---|---|---|---|
| Test Day | Mean (U/L) | Test Day | Mean (U/L) |
| 0 | 658 | 0 | 1595 |
| 8 | 654 | 8 | 1627 |
| 16 | 658 | 16 | 1607 |
| 36 | 653 | 36 | 1477 |
| 66 | 658 | 66 | 1568 |
| 98 | 653 | 98 | 1583 |
| 154 | 653 | 154 | 1625 |
| 196 | 665 | 196 | 1576 |
| 252 | 652 | 252 | 1575 |
| 317 | 656 | 317 | 1523 |
| 371 | 651 | 371 | 1576 |
| 470 | 655 | 470 | 1576 |

| | | | |
|---|---|---|---|
| Regression | Day 470 | Regression | Day 470 |
| through: | | through: | |
| p Value: | 0.546 | p Value: | 0.625 |
| p Value > 0.05? | Yes | p Value > 0.05? | Yes |
| Outcome | no drift | Outcome | no drift |
| Pass/Fail | Pass | Pass/Fail | Pass |
| Days Stable | 371 | Days Stable | 371 |

TABLE 6
Lot 5KD042

| | Level B Amylase | | Level B Lipase |
|---|---|---|---|
| Test Day | Mean (U/L) | Test Day | Mean (U/L) |
| 0 | 694 | 0 | 1739 |
| 40 | 690 | 40 | 1758 |
| 90 | 684 | 90 | 1665 |
| 147 | 685 | 147 | 1667 |
| 180 | 688 | 180 | 1679 |
| 237 | 689 | 237 | 1635 |
| 285 | 681 | 285 | 1632 |
| 316 | 683 | 316 | 1636 |
| 368 | 684 | 368 | 1622 |
| 396 | 688 | 396 | 1770 |

| | | | |
|---|---|---|---|
| Regression | Day 396 | Regression | Day 396 |
| through: | | through: | |
| p Value: | 0.099 | p Value: | 0.302 |
| p Value > 0.05? | Yes | p Value > 0.05? | Yes |
| Outcome | no drift | Outcome | no drift |
| Pass/Fail | Pass | Pass/Fail | Pass |
| Days Stable | 368 | Days Stable | 368 |

TABLE 7
Lot 6GD078

| | Level B Amylase | | Level B Lipase |
|---|---|---|---|
| Test Day | Mean (U/L) | Test Day | Mean (U/L) |
| 0 | 655 | 0 | 1570 |
| 16 | 655 | 16 | 1551 |
| 82 | 662 | 82 | 1586 |
| 146 | 655 | 146 | 1565 |
| 175 | 660 | 175 | 1595 |
| 217 | 653 | 217 | 1586 |
| 273 | 656 | 273 | 1550 |
| 320 | 651 | 320 | 1540 |
| 383 | 643 | 383 | 1543 |
| 447 | 650 | 447 | 1531 |

| | | | |
|---|---|---|---|
| Regression | Day 447 | Regression | Day 447 |
| through: | | through: | |
| p Value: | 0.038 | p Value: | 0.074 |
| p Value > 0.05? | No | p Value > 0.05? | Yes |
| Outcome | <5% Drift | Outcome | no drift |
| Pass/Fail | Pass | Pass/Fail | Pass |
| Days Stable | 383 | Days Stable | 383 |

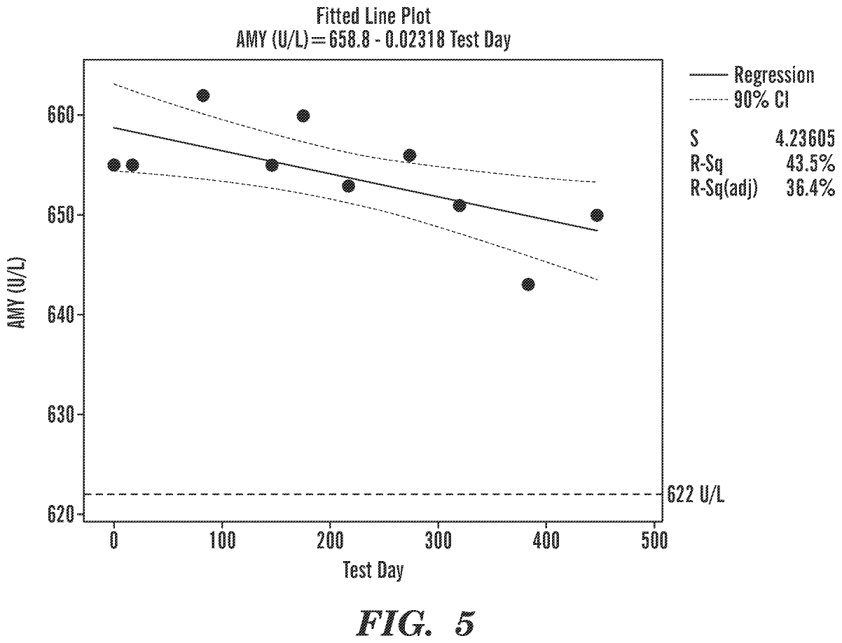

Since the p-value was less than 0.05 for the amylase samples in Lot 6GD078, the drift across the time duration of the study was analyzed. Linear regression in FIG. 5 shows that drift is less than 5% of the initial recovery and therefore amylase in Lot 6GD078 met the requirement.

All conducted shelf-life stability results for amylase and lipase met the acceptance criteria and support a 12-month shelf life for the A-LYTE® IMT Cleaner product when stored at 2 to 8° C.

### Example 7—In-Use Life Opened Vial Stability

Stability testing was performed to determine the duration over which products remain suitable for their intended use, under defined conditions of storage and handling. Products may demonstrate multiple types of stability behavior. In-use life stability is the period of time that a product remains viable once placed into use.

Opened vial stability was verified by measuring the amylase and lipase activity of an opened and recapped vial of A-LYTE® IMT Cleaner stored at 2 to 8° C. normalized to a freshly opened vial stored at 2 to 8° C. on each test day. For this analysis, the stability was determined by calculating the linear regression for each analyte, if the p-value for the regression slope was not significant (>0.05) then the stability was determined as the second to the last day of the study. If the p-value for the regression slope was significant (0.05) then the observed drift was compared to the acceptance criteria. The acceptance criteria was ≥30 days after opening when recapped and stored at 2 to 8° C., with an allowable drift of ≤33% for Amylase and ≤5% for Lipase.

Reagent: Dimension Vista AMY, Dimension Vista LIPL, and A-LYTE® IMT Cleaner. Sample: A-LYTE® IMT Cleaner. Acceptance Criteria: the product shall be stable for ≥30 days after opening when recapped and stored at 2 to 8° C. With an allowable drift of ≤3% for Amylase and ≤5% for Lipase.

Obtained results supported in-use life opened vial stability of 30 days for the A-LYTE® IMT Cleaner product after opening when recapped and stored at 2 to 8° C.

### Example 8—Bioburden

Bioburden testing was used to determine the extent of microbial contamination in a sample. The A-LYTE® IMT Cleaner is composed of several antimicrobials to limit bioburden, including Streptomycin Sulfate, Gentamicin Sulfate, Amphotericin B, and Clotrimazole Solution.

Bioburden testing was done on filled vials from a random sampling across the lot. A sample size of 35 vials per level was used. Each of the 7 samples submitted was a pooled mix of 5 vials of A-LYTE® IMT Cleaner, Level B. Samples were plated on letheen agar plates and incubated as follows: one half of the plates are incubated at 23-27° C. for at least two days, then moved to 33-37° C. for at least one day. The other half remain at 23-27° C. for at least three days. Bacterial colonies were counted on plates that have been incubated at 33-37° C., and fungi were counted on plates that were incubated at 23-27° C. The final result was reported as the number of bacteria and number of fungi per milliliter or gram of product. If no colonies appear on the plates, the count is reported as <10 CFU/mL. The results are shown in Table 8-10 below.

TABLE 8
BIOBURDEN VALIDATION LOT 1

| SAMPLE | DATE | # | # | | | LN OR |
|---|---|---|---|---|---|---|
| # | COMPLETED | BACTERIA | FUNGI | METHOD | SOURCE | OTHER |
| 36569 | Apr. 29, 2005 | <10 | <10 | AMY, GGT, LDH | HEPES/ | 5DD73-1 |
| | | | | | BSA | |
| 36570 | Apr. 29, 2005 | <10 | <10 | LIP, PCHE | HEPES/ | 5DD73-2 |
| | | | | | BSA | |
| 36571 | Apr. 29, 2005 | <10 | <10 | AMY, GGT, LDH | HEPES/ | 5DD73-3 |
| | | | | | BSA | |
| 36572 | Apr. 29, 2005 | <10 | <10 | LIP, PCHE | HEPES/ | 5DD73-4 |
| | | | | | BSA | |
| 36573 | Apr. 29, 2005 | <10 | <10 | AMY, GGT, LDH | HEPES/ | 5DD73-5 |
| | | | | | BSA | |
| 36574 | Apr. 29, 2005 | <10 | <10 | LIP, PCHE | HEPES/ | 5DD73-6 |
| | | | | | BSA | |
| 36575 | Apr. 29, 2005 | <10 | <10 | AMY, GGT, LDH | HEPES/ | 5DD73-7 |
| | | | | | BSA | |

TABLE 9
BIOBURDEN VALIDATION LOT 2

| SAMPLE | DATE | # | # | | | LN OR |
|---|---|---|---|---|---|---|
| # | COMPLETED | BACTERIA | FUNGI | METHOD | SOURCE | OTHER |
| 39716 | Jan. 30, 2006 | <10 | <10 | AMY, GGT, | BSA, | 5KDB42-1 |
| | | | | LDH, LIP, PCHE | HEPES | |
| 39717 | Jan. 30, 2006 | <10 | <10 | AMY, GGT, | BSA, | 5KDB42-2 |
| | | | | LDH, LIP, PCHE | HEPES | |
| 39718 | Jan. 30, 2006 | <10 | <10 | AMY, GGT, | BSA, | 5KDB42-3 |
| | | | | LDH, LIP, PCHE | HEPES | |
| 39719 | Jan. 30, 2006 | <10 | <10 | AMY, GGT, | BSA, | 5KDB42-4 |
| | | | | LDH, LIP, PCHE | HEPES | |
| 39720 | Jan. 30, 2006 | <10 | <10 | AMY, GGT, | BSA, | 5KDB42-5 |
| | | | | LDH, LIP, PCHE | HEPES | |
| 39721 | Jan. 30, 2006 | <10 | <10 | AMY, GGT, | BSA, | 5KDB42-6 |
| | | | | LDH, LIP, PCHE | HEPES | |
| 39722 | Jan. 30, 2006 | <10 | <10 | AMY, GGT, | BSA, | 5KDB42-7 |
| | | | | LDH, LIP, PCHE | HEPES | |

TABLE 10
BIOBURDEN VALIDATION LOT 3

| SAMPLE | DATE | # | # | | | LN OR |
|---|---|---|---|---|---|---|
| # | COMPLETED | BACTERIA | FUNGI | METHOD | SOURCE | OTHER |
| 42634 | Aug. 19, 2006 | <10 | <10 | AMY, GGT, | HEPES | 6GDB78-1 |
| | | | | LDH, LIP, PCHE | BSA | |
| 42635 | Aug. 19, 2006 | <10 | <10 | AMY, GGT, | HEPES | 6GDB78-2 |
| | | | | LDH, LIP, PCHE | BSA | |
| 42636 | Aug. 19, 2006 | <10 | <10 | AMY, GGT, | HEPES | 6GDB78-3 |
| | | | | LDH, LIP, PCHE | BSA | |
| 42637 | Aug. 19, 2006 | <10 | <10 | AMY, GGT, | HEPES | 6GDB78-4 |
| | | | | LDH, LIP, PCHE | BSA | |
| 42638 | Aug. 19, 2006 | <10 | <10 | AMY, GGT, | HEPES | 6GDB78-5 |
| | | | | LDH, LIP, PCHE | BSA | |
| 42639 | Aug. 19, 2006 | <10 | <10 | AMY, GGT, | HEPES | 6GDB78-6 |
| | | | | LDH, LIP, PCHE | BSA | |
| 42640 | Aug. 19, 2006 | <10 | <10 | AMY, GGT, | HEPES | 6GDB78-7 |
| | | | | LDH, LIP, PCHE | BSA | |

The bioburden for all samples across all 3 lots tested reported <10 CFU/mL of bacteria and fungi. Therefore, bioburden testing met the acceptance criteria for microbial growth of <100 CFU/mL.

### Example 9—Atellica Sample Handler Onboard Stability

Reagents: Atellica® CH Amylase, Atellica CH Lipase, Atellica CH SPCL CHEM CAL Lot 58103, and Atellica CH ENZ 1 Cal Lot 1MD033. Samples: A-LYTE® IMT Cleaner.

The stability of the A-LYTE® IMT Cleaner when stored onboard the Atellica Sample Handler was verified by measuring the amylase and lipase activity after vials were newly opened and the material placed on the Atellica Sample Handler for refrigerated storage. The data were normalized to a newly opened vial stored at 2 to 8° C. on each test day. For this analysis, the stability was determined by calculating the linear regression for each analyte, if the p-value for the regression slope was not significant (>0.05) then the stability was determined as the final day of testing minus one day. If the p-value for the regression slope was significant (≤0.05) then the observed drift was compared to the acceptance criteria.

The stability shall be >7 days as determined by an allowable drift of +/−15% for Amylase and +/−15% for Lipase activity after vials are freshly opened and the material placed on the Atellica Sample Handler for refrigerated storage.

| | | Amylase Bias | | | Lipase Bias |
|---|---|---|---|---|---|
| | Test | On Board | | Test | On Board |
| Date | Day | vs. Fresh (%) | Date | Day | vs. Fresh (%) |
| 22-Apr | 0 | 0.4% | 22-Apr | 0 | 0.2% |
| 26-Apr | 4 | 0.4% | 26-Apr | 4 | 0.1% |
| 2-May | 10 | 0.7% | 2-May | 10 | 0.2% |
| 9-May | 17 | 0.5% | 9-May | 17 | −0.1% |
| 16-May | 24 | 0.6% | 16-May | 24 | −0.4% |
| 23-May | 31 | −0.4% | 23-May | 31 | 0.3% |

### Regression Statistics:

| | Amylase | Lipase |
|---|---|---|
| Regression Through | Day 31 | Day 31 |
| Slope: | −0.000184 | −0.000039 |
| Slope P-value: | 0.261 | 0.734 |
| Is P-value > 0.05? | Yes | Yes |
| % drift within limit | Yes | Yes |
| Pass/Fail | Pass | Pass |
| Days Stable | 31 | 31 |

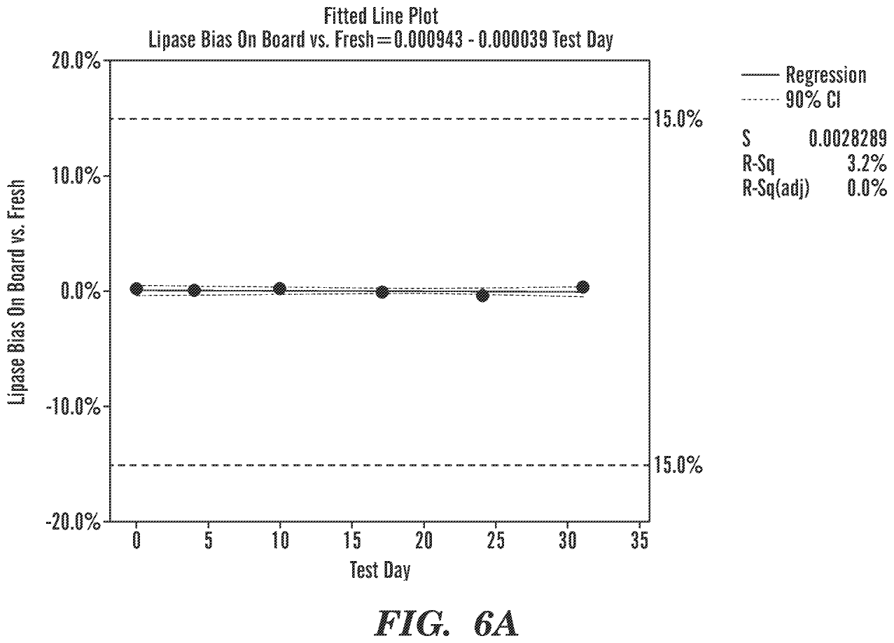

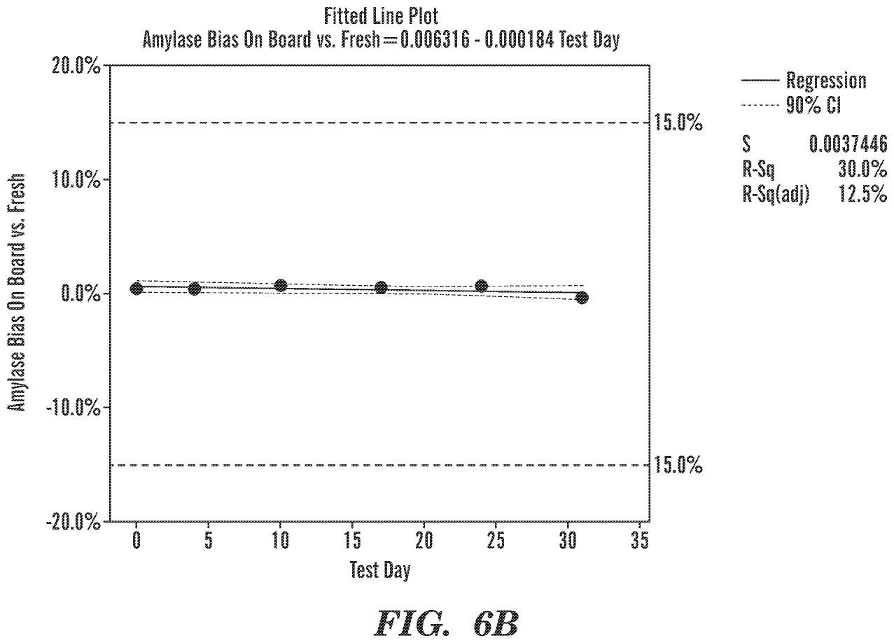

The results met the acceptance criteria and supported a stability duration of 30 days after vials are freshly opened and the material placed on the Atellica Sample Handler for the A-LYTE® IMT Cleaner product (FIGS. 6A-6B).

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A method of cleaning an electrode sub-system, said method comprising:
(a) providing a cleaning composition comprising:
(i) one or more cleaning enzymes;
(ii) one or more pH modulators;
(iii) one or more matrix components;
(iv) one or more buffer components; and
(v) one or more preservatives, wherein said cleaning composition has a pH range of from about 7.2 to about 7.4; and
(b) flowing the cleaning composition through the electrode sub-system, wherein the electrode sub-system comprises an inlet port, one or more sensors, an outlet port, and a fluid flow channel connecting said inlet port, said one or more sensors, and said outlet port.

2. The method of claim 1, further comprising:
(c) flowing a rinsing solution through the electrode sub-system, wherein said flowing a rinsing solution is effective to remove any residual cleaning composition from the electrode sub-system.

3. The method of claim 1, wherein said cleaning composition is substantially free of sodium hypochlorite.

4. The method of claim 1, wherein said one or more cleaning enzymes is selected from the group consisting of an amylase, a lipase, and combinations thereof.

5. The method of claim 1, wherein the one or more pH modulators is selected from the group consisting of hydrochloric acid, sodium hydroxide, potassium hydroxide, calcium hydroxide, phosphoric acid, tetramethylammonium hydroxide, CAPSO free acid, citric acid, acetic acid, CHES, borate, and combination thereof.

6. The method of claim 1, wherein said one or more matrix components is selected from the group consisting of bovine serum albumin, human serum albumin, zinc chloride, and magnesium chloride hexahydrate.

7. The method of claim 1, wherein said one or more buffer components is selected from the group consisting of HEPES Free Acid, HEPES Na Salt, phosphate, Tris, TES, MOPS, PIPES, TAPS, Bicine, Tricine, CAPSO, Cacodylate, and MES.

8. The method of claim 1, wherein said one or more preservatives is selected from the group consisting of streptomycin sulfate, gentamycin sulfate, amphotericin B, clortrimazole, chloramphenicol, ampicillin, neomycin sulfate, isothiazolinones, and sodium gallate.

9. The method of claim 1, wherein said cleaning composition further comprises a diluent.

10. The method of claim 9, wherein said diluent is selected from the group consisting of water, a buffer, a saline-based solution, a preservative, a pH modulator, and albumin.

11. The method of claim 1, further comprising:
(d) calibrating the sensor.

12. A method of cleaning an electrode sub-system, said method comprising:
(a) providing a cleaning composition comprising:
(i) lipase;
(ii) amylase;
(iii) one or more pH modulators selected from hydrochloric acid and sodium hydroxide;
(iv) one or more matrix components selected from the group consisting of bovine serum albumin, zinc chloride, and magnesium chloride hexahydrate;
(v) HEPES buffer; and
(vi) one or more preservatives selected from the group consisting of streptomycin sulfate, gentamicin sulfate, amphotericin B, and clotrimazole;
wherein said cleaning composition has a pH range of from about 7.2 to about 7.4; and
(b) flowing the cleaning composition through the electrode sub-system, wherein the electrode sub-system comprises an inlet port, one or more sensors, an outlet port, and a fluid flow channel connecting said inlet port, said one or more sensors, and said outlet port.

13. The method of claim 12, further comprising:
(c) flowing a rinsing solution through the electrode sub-system, wherein said flowing a rinsing solution is effective to remove any residual cleaning composition from the electrode sub-system.

14. The method of claim 12, wherein said cleaning composition further comprises a diluent.

15. The method of claim 14, wherein said diluent is selected from the group consisting of water, a buffer, a saline-based solution, a preservative, a pH modulator, and albumin.

16. The method of claim 12, further comprising:
(d) calibrating the sensor.

17. The method of claim 1, wherein the amylase is present in the cleaning composition in an amount of at least 60 U/L.

18. The method of claim 1, wherein the lipase is present in the cleaning composition in an amount of at least 100 U/L.

19. The method of claim 12, wherein the cleaning composition comprises:

| Component | Concentration |
|---|---|
| Lipase | from about 100 to about 16000 U/L |
| Amylase | from about 50 to about 8000 U/L |
| Pseudocholinesterase (PCHE) | from about 1 to about 200 U/mL |
| Gamma-glutamyl Transpeptidase | from about 50 to about 9000 U/L |
| (GGT) | |
| Lactate Dehydrogenase (LDH) | from about 50 to about 7000 U/L |

20. The method of claim 12, wherein the cleaning composition comprises:

| Component | Concentration |
|---|---|
| Lipase | from about 150 to about 1600 U/L |
| Amylase | from about 70 to about 800 U/L |
| Pseudocholinesterase (PCHE) | from about 1 to about 20 U/mL |
| Gamma-glutamyl Transpeptidase | from about 80 to about 875 U/L |
| (GGT) | |
| Lactate Dehydrogenase (LDH) | from about 60 to about 700 U/L |
| Magnesium Chloride Hexahydrate | from about 0.04 to about 0.55 g/L |
| Zinc Chloride | from about 1 to about 20 mg/L |
| HEPES (acid) | from about 1 to about 12 g/L |
| Sodium HEPES | from about 0.25 to about 3.5 g/L |
| Streptomycin Sulfate | from about 0.01 to about 0.15 g/L |
| Gentamicin Sulfate | from about 0.01 to about 0.15 g/L |
| Amphotericin B | from about 2.5 to about 30 mg/L |
| Clotrimazole | from about 1.5 to about 20 mg/L |
| Bovine Albumin | from about 6 to about 75 g/L |

21. The method of claim 12, wherein the cleaning composition comprises:

| Component | Concentration |
|---|---|
| Lipase | about 1562 U/L |
| Amylase | about 725 U/L |
| Pseudocholinesterase (PCHE) | about 14.7 U/mL |
| Gamma-glutamyl Transpeptidase (GGT) | about 840 U/L |
| Lactate Dehydrogenase (LDH) | about 650 U/L |
| Magnesium Chloride Hexahydrate | about 0.468 g/L |
| Zinc Chloride | about 15.7 mg/L |
| HEPES (acid) | about 10.9 g/L |
| Sodium HEPES | about 2.99 g/L |
| Streptomycin Sulfate | about 0.115 g/L |
| Gentamicin Sulfate | about 0.115 g/L |
| Amphotericin B | about 28.7 mg/L |
| Clotrimazole | about 17.68 mg/L |
| Bovine Albumin | about 69 g/L |

22. The method of claim 1, wherein the electrode sub-system is positioned inside a clinical or chemistry analyzer.

23. The method of claim 1, wherein each of the one or more sensors present in the electrode sub-system have a use life time and wherein the use of the cleaning composition to clean the electrode sub-system extends the use life time for the sensor.

24. The method of claim 1, wherein the sensor is an ion selective sensor.

25. The method of claim 1, wherein the fluid flow channel comprises one or more of tubing or passages in a manifold.
